(19) United States
(12) Patent Application Publication
(10) Pub. No.: US 2007/0225185 A1
(43) Pub. Date: Sep. 27, 2007

(54) Ink washing liquid and cleaning method

(75) Inventor: Seishi Kasai, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, TOKYO (JP)

(21) Appl. No.: 11/723,465

(22) Filed: Mar. 20, 2007

(30) Foreign Application Priority Data
Mar. 22, 2006 (JP) 2006-079194
Mar. 22, 2006 (JP) 2006-079215
Mar. 22, 2006 (JP) 2006-079224

(51) Int. Cl. C11D 9/00

(52) U.S. Cl. 510/170; 510/506

(57) ABSTRACT

An ink washing liquid for a photocurable ink is provided, the liquid including at least one type of ether compound. There is also provided a cleaning method for an inkjet printer, the method including cleaning the inkjet printer with the ink washing liquid.

### BACKGROUND OF THE INVENTION

1. Field of the Invention

The present invention relates to a novel ink washing liquid and an inkjet printer cleaning method.

2. Description of the Related Art

With regard to an image recording method for forming an image on a recording medium such as paper based on an image data signal, there are an electrophotographic system, sublimation type and melt type thermal transfer systems, an inkjet system, etc. In the electrophotographic system, a process of forming an electrostatic latent image on a photosensitive drum by electrically charging and exposing is required, and the system is complicated; as a result, there is the problem that the production cost is high. With regard to the thermal transfer system, although the equipment is inexpensive, due to the use of an ink ribbon there is the problem that the running cost is high and waste material is generated.

On the other hand, with regard to the inkjet system, the equipment is inexpensive and, since an image is formed directly on a recording medium by discharging an ink only on a required image area, the ink can be used efficiently and the running cost is low. Furthermore, there is little noise and it is excellent as an image recording system.

With regard to inks used for inkjet printers, there are wax inks, which are solid at normal temperature, solvent inks, which mainly comprise an aqueous solvent or an organic solvent, photocurable inks, which cure upon exposure to light, etc. Among them, photocurable inks are attracting attention since they have low odor compared with other recording systems and can record not only on special paper but also on a recording medium that does not have fast-drying properties or ink absorbing properties.

As the photocurable ink, there are a radically polymerizable photocurable ink in which a monomer or an oligomer polymerizes using a radical generated by irradiation with light as a growth active species, and a cationically polymerizable photocurable ink in which a monomer or an oligomer polymerizes using a cation generated by irradiation with light as a growth active species.

Since an inkjet printer discharges ink via a very small diameter discharge orifice formed in a head, the ink might, become attached to the head, the surroundings of the discharge orifice, or another inkjet printer component, or the discharge orifice might be blocked by the ink being cured in the discharge orifice. Various measures are being taken against these types of problems.

As a countermeasure technique for preventing ink from clogging a discharge orifice, there is a technique in which the discharge orifice is covered with a cap when the inkjet printer is not recording an image, and this technique is disclosed in, for example, JP-A-57-117964 (JP-A denotes a Japanese unexamined patent application publication). As another countermeasure technique, there is a technique in which ink attached to the vicinity of a discharge orifice is wiped off when the inkjet printer is recording an image or completing recording of the image, and such a technique is disclosed in, for example, JP-A-57-80064, JP-A-59-111856, JP-A-8-1953, and JP-B-62-9030 (JP-B denotes a Japanese examined patent application publication). Furthermore, JP-B-62-9030 discloses a technique in which silicon oil or ethylene glycol is used when ink is wiped off the discharge orifice. Moreover, JP-A-4-261476 discloses an inkjet printer washing liquid comprising isothiazolone and having excellent washing power and an antimold and antimicrobial effect.

### BRIEF SUMMARY OF THE INVENTION

However, the techniques disclosed by the prior arts are not sufficient for washing an ink composition. In particular, the washing properties were not sufficient for a photocurable oil-soluble ink.

It is therefore an object of the present invention to provide an ink washing liquid for a photocurable ink and a cleaning method for an inkjet printer, the ink washing liquid having excellent cleaning properties for the photocurable ink.

The above-mentioned object of the present invention has been accomplished by means described in (1) below. (2) to (13), which are preferred embodiments, are also described below.

### (1) An ink washing liquid for a photocurable ink, the liquid comprising at least one type of ether compound,

(2) the ink washing liquid according to (1), wherein the ether compound is a glycol ether compound,
(3) the ink washing liquid according to (1), wherein the photocurable ink is a radically polymerizable ink,
(4) a cleaning method for an inkjet printer, the method comprising cleaning an inkjet printer with the ink washing liquid according to (1),
(5) the ink washing liquid according to (1), wherein it further comprises at least one type of pigment-dispersing agent,
(6) the ink washing liquid according to (5), wherein the ether compound is a glycol ether compound,
(7) the ink washing liquid according to (5), wherein the photocurable ink is a radically polymerizable ink,
(8) a cleaning method for an inkjet printer, the method comprising cleaning an inkjet printer with the ink washing liquid according to (5),
(9) the ink washing liquid according to (1), wherein it further comprises at least one type of basic compound,
(10) the ink washing liquid according to (9), wherein the ether compound is a glycol ether compound,
(11) the ink washing liquid according to (9), wherein the basic compound is an organic amine,
(12) the ink washing liquid according to (9), wherein the photocurable ink is a radically polymerizable ink, and
(13) a cleaning method for an inkjet printer, the method comprising cleaning an inkjet printer with the ink washing liquid according to (9).

### DETAILED DESCRIPTION OF THE INVENTION

The present invention is explained below in further detail.

The ink washing liquid of the present invention is an ink washing liquid for a photocurable ink and comprises at least one type of ether compound.

The ink washing liquid of the present invention preferably comprises at least one type of pigment-dispersing agent in addition to the ether compound.

Furthermore, the ink washing liquid, of the present invention preferably comprises at least one type of basic compound in addition to the ether compound.

### (1) Ink Washing Liquid

The ink washing liquid (hereinafter, also called simply a ‘washing liquid’) of the present invention comprises at least an ether compound, and can be used suitably for washing a photocurable ink from an inkjet printer that discharges the photocurable ink from a head.

The ink washing liquid of the present invention has the action of dissolving and/or dispersing uncured or cured photocurable ink, and this allows it to be used as a washing liquid for photocurable ink before and after curing.

The ink washing liquid of the present invention is now explained.

### Ether Compound

In the present invention, the ink washing liquid comprises at least one type of ether compound.

Examples of the ether compound that can be used in the present invention include a monoether and an ether compound comprising a polyol such as a glycol, a triol, or a tetraol.

When the washing liquid comprises an ether compound, it is possible to carry out cleaning without making insoluble components in the ink aggregate, stable operation without head clogging is possible in a situation in which cleaning is necessary when restarting equipment after replacing a solution or after it has been inactive for a long period of time and, furthermore, the continuous discharge reliability during printing is improved by its use in cleaning after the head is clogged.

In the present invention, any ether compound may be used as long as it is a compound having an ether group (—O—) in the molecule, and among such compounds it is preferable to use a glycol ether compound as the ether compound.

Examples of the glycol ether compound include compounds represented by Formula (I) or (II) below, but the present invention is not limited thereto.

R¹O—(CH₂CH(R²)—O)ₘ—R³ (I)

R⁴O—(CH₂CH₂—O)ₚ—CO—CH₃ (II)

In the formulae, R¹ to R⁴ independently denote a hydrogen atom, an alkyl group having 1 to 8 carbons, a benzyl group, a phenyl group, a vinyl group, an allyl group, an acrylic group, a methacrylic group, or a cyclic alkyl group having 5 to 10 carbons, and m and p denote an integer of 1 to 20.

Specific examples thereof include triethylene glycol divinyl ether, diethylene glycol divinyl ether, triethylene glycol diacrylate, diethylene glycol diacrylate, ethylene glycol monomethyl ether, diethylene glycol monomethyl ether, triethylene glycol monomethyl ether, diethylene glycol dimethyl ether, ethylene glycol monomethyl ether acetate, ethylene glycol monoethyl ether, diethylene glycol monoethyl ether, triethylene glycol monoethyl ether, diethylene glycol diethyl ether, ethylene glycol monoethyl ether acetate, ethylene glycol monobutyl ether, diethylene glycol monobutyl ether, triethylene glycol monobutyl ether, diethylene glycol dibutyl ether, ethylene glycol monobutyl ether acetate, ethylene glycol monobenzyl ether, diethylene glycol monobenzyl ether, propylene glycol monomethyl ether, dipropylene glycol monomethyl ether, tripropylene glycol monomethyl ether, dipropylene glycol dimethyl ether, propylene glycol monoethyl ether, dipropylene glycol monoethyl ether, tripropylene glycol monoethyl ether, dipropylene glycol diethyl ether, tripropylene glycol divinyl ether, dipropylene glycol divinyl ether, tripropylene glycol diacrylate, and dipropylene glycol diacrylate.

Among them, preferred examples of the glycol ether compound include tripropylene glycol monomethyl ether, dipropylene glycol monomethyl ether, propylene glycol monomethyl ether, triethylene glycol divinyl ether, dipropylene glycol diacrylate, ethylene glycol monobutyl ether, diethylene glycol monobutyl ether, triethylene glycol monobutyl ether, ethylene glycol monobenzyl ether, diethylene glycol monobenzyl ether, tripropylene glycol divinyl ether, dipropylene glycol divinyl ether, and tripropylene glycol diacrylate.

Further examples of the ether compound that can be used in the present invention include polyethylene glycols and polypropylene glycols having a molecular weight of 200 to 1,000, and monomethyl ethers, monoethyl ethers, monopropyl ethers, monoisopropyl ethers, and monobutyl ethers of these compounds.

Moreover, in the present invention, it is preferable to use an alkoxy alcohol as the ether compound. An alkoxy alcohol having 1 to 6 carbons is preferable, and preferred examples thereof include 3-methoxybutanol and 3-methyl-3-methoxybutanol.

In the present invention, the ether compound used in the ink washing liquid preferably has a viscosity at 25° C. of 1 to 40 mPa·s, and more preferably 2 to 30 mPa·s. It is preferable for the viscosity to be in the above-mentioned range since a particularly excellent washing effect can be exhibited for washing the interior of a head.

In the present invention, the ether compound preferably has a boiling point of 50° C. to 150° C., and more preferably 60° C. to 130° C. It is preferable for the boiling point to be in the above-mentioned range since there is little residual washing liquid after use, there is no vaporization during use, and it can be used safely and effectively.

In the present invention, the amount of ether compound added is preferably 100 to 30 wt % of the entire ink washing liquid, more preferably 100 to 40 wt %, and further preferably 100 to 50 wt %. It is preferable for the amount added to be in the above-mentioned range since degeneration of a member due to other components can be suppressed and the effects expected for the present invention can be maintained. That is, it is preferable since degeneration by other components of the object from which ink is washed, such as an inkjet head, can be suppressed.

Furthermore, in the present invention, when a glycol ether is used as the ether compound, the amount thereof added is preferably 100 to 30 wt % of the entire ink washing liquid, more preferably 100 to 40 wt %, and yet more preferably 100 to 50 wt %. It is preferable for the amount added to be in the above-mentioned range since degeneration of a member by other components can be suppressed and the effects expected for the present invention can be maintained.

Other components contained in the ink washing liquid of the present invention are explained.

### Pigment-Dispersing Agent

The ink washing liquid of the present invention preferably comprises a pigment-dispersing agent in addition to the ether compound. The pigment-dispersing agent has the capability of dispersing a pigment contained in a photocurable ink. Since the ink washing liquid of the present invention comprises a pigment-dispersing agent, it is possible to suppress aggregation of a pigment contained in a photocurable ink, and wash the photocurable ink effectively, and it is therefore preferable for it to comprise a pigment-dispersing agent.

Specific examples of the pigment-dispersing agent include a nonionic surfactant and a polymeric pigment-dispersing agent. Examples of the nonionic surfactant include sorbitan fatty acid esters (sorbitan monooleate, sorbitan monolaurate, sorbitan sesquioleate, sorbitan trioleate, etc.), polyoxyethylene sorbitan fatty acid esters (polyoxyethylene sorbitan monostearate, polyoxyethylene sorbitan monooleate, etc.), polyethylene glycol fatty acid esters (polyoxyethylene monostearate, polyethylene glycol diisostearate, etc.), polyoxyethylene alkyl phenyl ethers (polyoxyethylene nonyl phenyl ether, polyoxyethylene octyl phenyl ether, etc.), and aliphatic diethanolamides. The polymeric dispersing agent is preferably a polymer compound having a molecular weight of 1,000 or greater, and examples thereof include a styrene-maleic acid resin, a styrene-acrylic resin, rosin, BYK-160, 162, 164, and 182 (urethane-based polymer compounds manufactured by BYK Chemie), EFKA 47 and LP-4050 (urethane-based dispersing agents manufactured by EFKA), Solsperse 24000 (polyester-based polymer compound manufactured by Noveon), and Solsperse 17000 (aliphatic diethanolamide-based compound manufactured by Noveon).

Other examples of the polymeric pigment-dispersing agent include a random copolymer comprising a solvent-soluble monomer such as lauryl methacrylate, stearyl methacrylate, 2-ethylhexyl methacrylate, or cetyl methacrylate, a poorly solvent-soluble monomer such as methyl methacrylate, ethyl methacrylate, isopropyl methacrylate, styrene, or vinyl toluene, and a moiety having a polar group, and a graft copolymer disclosed in JP-A-3-188469. Examples of the above-mentioned monomer having a polar group include acidic group monomers such as acrylic acid, methacrylic acid, itaconic acid, fumaric acid, maleic acid, styrenesulfonic acid, and alkali salts thereof, and basic group monomers such as dimethylaminoethyl methacrylate, diethylaminoethyl methacrylate, vinylpyridine, vinylpyrrolidine, vinylpiperidine, and vinyllactam. Other examples include a styrene-butadiene copolymer, and a block copolymer of styrene and a long-chain alkyl methacrylate disclosed in JP-A-60-10263. Preferred examples of the pigment-dispersing agent include a graft copolymer disclosed in JP-A-3-188469.

Specific examples of the pigment-dispersing agent include Solsperse 3000 (manufactured by Noveon), Solsperse 5000 (manufactured by Noveon), Solsperse 12000 (manufactured by Noveon), Solsperse 22000 (manufactured by Noveon), Solsperse 36000 (manufactured by Noveon), Solsperse 41000 (manufactured by Noveon), Solsperse 71000 (manufactured by Noveon), BYK-111 (manufactured by BYK Chemie), BYK-162 (manufactured by BYK Chemie), BYK-168 (manufactured by BYK Chemie), BYK-174 (manufactured by BYK Chemie), EFKA 4010 (manufactured by EFKA), EFKA 4800 (manufactured by EFKA), EFKA 5244 (manufactured by EFKA), EFKA 7414 (manufactured by EFKA), Disparlon DA-234 (manufactured by Kusumoto Chemicals, Ltd.), Disparlon DA-555 (manufactured by Kusumoto Chemicals, Ltd.), Disparlon DA-7300 (manufactured by Kusumoto Chemicals, Ltd.), Ajisper PN-411 (manufactured by Ajinomoto Fine-Techno Co., Inc.), and Ajisper PN-822 (manufactured by Ajinomoto Fine-Techno Co., Inc.).

Among them, preferred examples of the pigment-dispersing agent include Solsperse 36000 (manufactured by Noveon), Solsperse 41000 (manufactured by Noveon), Solsperse 71000 (manufactured by Noveon), BYK-111 (manufactured by BYK Chemie), BYK-162 (manufactured by BYK Chemie), BYK-168 (manufactured by BYK Chemie), EFKA 5244 (manufactured by EFKA), EFKA 7414 (manufactured by EFKA), Disparlon DA-555 (manufactured by Kusumoto Chemicals, Ltd.), Disparlon DA-7300 (manufactured by Kusumoto Chemicals, Ltd.), Ajisper PN-411 (manufactured by Ajinomoto Fine-Techno Co., Inc.), and Ajisper PN-822 (manufactured by Ajinomoto Fine-Techno Co., Inc.), more preferred examples thereof include Solsperse 36000 (manufactured by Noveon), Solsperse 71000 (manufactured by Noveon), BYK-162 (manufactured by BYK Chemie), BYK-168 (manufactured by BYK Chemie), EFKA 5244 (manufactured by EFKA), EFKA 7414 (manufactured by EFKA), Disparlon DA-7300 (manufactured by Kusumoto Chemicals, Ltd.), Ajisper PN-411 (manufactured by Ajinomoto Fine-Techno Co., Inc.), and Ajisper PN-822 (manufactured by Ajinomoto Fine-Techno Co., Inc.), and particularly preferred examples thereof include Solsperse 71000 (manufactured by Noveon), BYK-162 (manufactured by BYK Chemie), BYK-168 (manufactured by BYK Chemie), EFKA 7414 (manufactured by EFKA), Disparlon DA-7300 (manufactured by Kusumoto Chemicals, Ltd.), and Ajisper PN-822 (manufactured by Ajinomoto Fine-Techno Co., Inc.).

The amount of pigment-dispersing agent used is preferably 1 to 40 parts by weight relative to 100 parts by weight of the ink washing liquid, and more preferably 3 to 30 parts by weight. It is preferable for the amount of pigment-dispersing agent added to be within the above-mentioned range since a sufficient ink washing effect can be obtained.

### Basic Compound

The ink washing liquid of the present invention also preferably comprises a basic compound. When the ink washing liquid of the present invention comprises a basic compound, an acid generated in a photocurable ink is neutralized and curing of the photocurable ink can be suppressed, and it is therefore preferable for it to comprise a basic compound. It can also be expected that, as a result, the washing properties of the ink washing liquid can be enhanced.

In the present invention, the basic compound functions as a polymerization inhibitor for both cationically polymerizable and radically polymerizable photocurable inks.

Examples of the basic compound used in the present invention include an organic amine and a hydroxide of an alkali metal, and it is preferable to use an organic amine as the basic compound.

Examples of the hydroxide of the alkali metal include sodium hydroxide, potassium hydroxide, and lithium hydroxide.

### Organic Amine

Specific examples of the organic amine used in the present invention include primary, secondary, and tertiary aliphatic amines (methylamine, ethylamine, propylamine, n-butylamine, n-hexylamine, 2-ethylhexylamine, dimethylamine, diethylamine, di-n-butylamine, di-n-hexylamine, methylethylamine, ethyl-n-butylamine, triethylamine, tri-n-butylamine, tri-n-hexylamine, dimethylethylamine, diethyl-n-butylamine, etc.), primary, secondary, and tertiary aromatic amines (phenylamine, naphthylamine, p-bromophenylamine, p-methoxyphenylamine, m-bromophenylamine, methylphenylamine, ethylphenylamine, methylnaphthylamine, n-butylphenylamine, 2-ethylhexylphenylamine, diphenylamine, dimethylphenylamine, diethylphenylamine, triphenylamine, methyldiphenylamine, n-butyldiphenylamine, etc.), hydrazines (hydrazine, dimethylhydrazine, diethylhydrazine, etc.), N atom-containing heterocycles (pyridine, imidazole, oxazoline, triazole, etc.), primary, secondary, and tertiary alkanolamines (ethanolamine, diethanolamine, triethanolamine, propanolamine, dipropanolamine, tripropanolamine, butanolamine, hexanolamine, etc.), 3-aminopropyltriethoxysilane, 3-aminopropyltrimethoxysilane, 3-dimethylaminopropyltriethoxysilane, 3-dimethylaminopropyltrimethoxysilane, 2-aminoethyltriethoxysilane, 2-aminoethyltrimethoxysilane, 2-dimethylaminoethyltriethoxysilane, 2-dimethylaminoethyltrimethoxysilane, 4-aminophenyltriethoxysilane, 4-dimethylaminophenyltriethoxysilane, 3-dimethylaminopropylzirconium triethoxide, and 3-dimethylaminopropyltitanium triethoxide.

Among them, preferred examples thereof include 2-ethylhexylamine, tri-n-hexylamine, dimethylethylamine, diethyl-n-butylamine, p-methoxyphenylamine, ethylphenylamine, methylnaphthylamine, n-butylphenylamine, 2-ethylhexylphenylamine, diphenylamine, triphenylamine, n-butyldiphenylamine, pyridine, imidazole, oxazoline, triazole, ethanolamine, diethanolamine, triethanolamine, propanolamine, dipropanolamine, tripropanolamine, butanolamine, hexanolamine, 3-aminopropyltriethoxysilane, 3-aminopropyltrimethoxysilane, 3-dimethylaminopropyltriethoxysilane, 3-dimethylaminopropyltrimethoxysilane, 2-aminoethyltriethoxysilane, 2-aminoethyltrimethoxysilane, 2-dimethylaminoethyltriethoxysilane, 2-dimethylaminoethyltrimethoxysilane, 4-aminophenyltriethoxysilane, 4-dimethylaminophenyltriethoxysilane, 3-dimethylaminopropylzirconium triethoxide, and 3-dimethylaminopropyltitanium triethoxide, and more preferred examples thereof include tri-n-hexylamine, diethyl-n-butylamine, p-methoxyphenylamine, ethylphenylamine, methylnaphthylamine, 2-ethylhexylphenylamine, diphenylamine, triphenylamine, imidazole, oxazoline, triazole, ethanolamine, diethanolamine, triethanolamine, propanolamine, dipropanolamine, tripropanolamine, butanolamine, hexanolamine, 3-aminopropyltriethoxysilane, 3-aminopropyltrimethoxysilane, 3-dimethylaminopropyltriethoxysilane, 3-dimethylaminopropyltrimethoxysilane, 2-aminoethyltriethoxysilane, 2-aminoethyltrimethoxysilane, 2-dimethylaminoethyltriethoxysilane, 2-dimethylaminoethyltrimethoxysilane, 4-aminophenyltriethoxysilane, and 4-dimethylaminophenyltriethoxysilane. The above-mentioned compounds are preferable since they have excellent solubility in the washing liquid and do not vaporize or separate from the washing liquid.

In the present invention, the basic compound may be used singly or in a combination of a plurality types thereof.

In the ink washing liquid of the present invention, the content of the basic compound is preferably 1 to 60 wt % of the ink washing liquid, more preferably 5 to 55 wt %, and more preferably 10 to 50 wt %.

It is preferable for the content of the basic composition to be in the above-mentioned range since good washing properties can be obtained.

The ink washing liquid of the present invention may comprise another component in addition to the above-mentioned ether compound. Examples of the other component include an alcohol, an ester, a ketone, a lactone, a lactam, and other components.

### Alcohol

As the alcohol in the ink washing liquid of the present invention, an alcohol having 1 to 6 carbons is preferable.

As the alcohol having 1 to 6 carbons, it is possible to use a straight-chain alcohol, a branched alcohol, a cyclic alcohol, a branched cyclic alcohol, etc. Examples thereof include tetrahydrofurfuryl alcohol, methyl alcohol, ethyl alcohol, propyl alcohol and isomers thereof, butyl alcohol and isomers thereof, pentyl alcohol and isomers thereof, and hexyl alcohol and isomers thereof.

The ink washing liquid of the present invention may comprise one or more types of alcohol having 1 to 6 carbons. Among them, propyl alcohol and isomers thereof, and butyl alcohol and isomers thereof are suitable. Since an alcohol having 7 carbons or more tends to have poor ink removing properties, it is preferable to use an alcohol having 1 to 6 carbons.

The amount of alcohol having 1 to 6 carbons in the ink washing liquid of the present invention is preferably 3 to 30 wt % of the entire ink washing liquid, and more preferably 5 to 12 wt %.

It is preferable for the amount added to be in the above-mentioned range since degeneration of a member is suppressed and the washing effect expected in the present invention can be maintained.

### Ester

Specific examples of the ester that can be used in the present invention include amyl acetate, isoamyl acetate, methylisoamyl acetate, sec-hexyl acetate, 2-ethylbutyl acetate, 2-ethylhexyl acetate, cyclohexyl acetate, methylcyclohexyl acetate, benzyl acetate, butyl propionate, isoamyl propionate, butyl butyrate, isobutyl butyrate, isoamyl butyrate, methyl lactate, ethyl lactate, butyl lactate, amyl lactate, and isoamyl lactate.

The amount of ester added is preferably 0 to 50 wt % of the entire ink washing liquid, more preferably 0 to 40 wt %, and yet more preferably 0 to 30 wt %. It is preferable for the amount added to be in the above-mentioned range since degeneration of a member is suppressed and the washing effect expected in the present invention can be maintained.

### Ketone

Specific examples of the ketone that can be used in the present invention include methyl amyl ketone, methyl n-hexyl ketone, di-n-propyl ketone, diacetone alcohol, acetonyl acetone, isophorone, phorone, cyclohexanone, methylcyclohexanone, and acetophenone.

The amount of ketone added is preferably 0 to 40 wt % of the entire ink washing liquid, more preferably 0 to 30 wt %, and yet more preferably 0 to 20 wt %. It is preferable for the amount added to be in the above-mentioned range since degeneration of a member is suppressed and the washing effect expected in the present invention can be maintained.

### Lactone and Lactam

Examples of the lactone that can be used in the present invention include a lactone having 3 to 6 carbons, and examples of the lactam that can be used in the present invention include a lactam having 4 to 7 carbons. Specific examples thereof include γ-butyrolactone, α-methyl-γ-butyrolactone, γ-valerolactone, γ-caprolactone, γ-laurolactone, δ-valerolactone, hexanolactone, 2-pyrrolidone, N-methyl-2-pyrrolidone, N-ethyl-2-pyrrolidone, and N-octyl-2-pyrrolidone.

The amounts of lactone and lactam added are preferably 0 to 50 wt % of the entire ink washing liquid, more preferably 0 to 40 wt %, and yet more preferably 0 to 30 wt %. It is preferable for the amounts added to be in the above-mentioned range since degeneration of a member is suppressed and the washing effect expected in the present invention can be maintained.

### Others

The ink washing liquid of the present invention may comprise another component.

Examples of the other component include N,N-dimethylformamide, N,N-dimethylacetamide, dimethyl carbonate, diethyl carbonate, ethylene carbonate, propylene carbonate, dimethylsulfoxide, tetramethylurea, and dimethylimidazolidinone.

The amount of other component added is preferably 0 to 40 wt % of the entire ink washing liquid, more preferably 0 to 30 wt %, and yet more preferably 0 to 20 wt %. It is preferable for the amount added to be in the above-mentioned range since degeneration of a member is suppressed and the washing effect expected in the present invention can be maintained.

The above-mentioned ink washing liquid comprising an ether compound may comprise a surfactant or an anti-foaming agent. It is preferable to add a surfactant to the ink washing liquid since this enables the surface energy of the ink washing liquid to be adjusted, and when the ink washing liquid is applied on an inkjet printer, the wettability of the inkjet printer by the ink washing liquid can be improved. Furthermore, it is preferable to add an anti-foaming agent to the washing liquid since it is possible to prevent foam being generated in the ink washing liquid.

Moreover, in the present invention it is also preferable for the ink washing liquid to comprise any compound that scavenges a radical (radical scavenger). In particular, when the photocurable ink is a radically polymerizable ink, it is preferable to add a radical scavenger. It is preferable to scavenge a radical since polymerization of the photocurable ink can be suppressed, thus further enhancing the washing properties.

Specific examples thereof include a phenol derivative such as hydroquinone or 4-methoxyhydroxybenzene and an oxygen- and sulfur-containing compound such as phenothiazine. Examples thereof also include methoquinone, DOHQ (Wako), and DHHQ (Wako).

The amount of radical scavenger added is preferably 0.1 to 10 wt % relative to the ink washing liquid, and more preferably 0.3 to 6 wt %. It is preferable for the amount added to be in the above-mentioned range since the washing effect can be enhanced.

An explanation of the washing liquid is given above, and an explanation is given below of the photocurable ink (in the present invention, the ‘photocurable ink’ is also called an ‘ink composition’) used in an inkjet printer.

In the present invention, the ‘photocurable ink’ means both the ink before curing and the ink after curing. Furthermore, the ‘ink composition’ in particular means the photocurable ink before curing.

### (2) Photocurable Ink

In the present invention, the photocurable ink (ink composition) can be cured by radiation or heat, comprises (a) a polymerizable compound and (b) a polymerization initiator, and may comprise as necessary (c) a colorant, (d) a sensitizing dye, (e) a co-sensitizer, and (f) another component.

The ‘radiation’ referred to in the present invention is not particularly limited as long as it is actinic radiation that can provide energy that enables a polymerization initiating species to be generated in the photocurable ink when irradiated, and broadly includes α rays, γ rays, X rays, ultraviolet rays (UV), visible light, and an electron beam; among these, ultraviolet rays and an electron beam are preferable from the viewpoint of curing sensitivity and the availability of equipment, and ultraviolet rays are particularly preferable. The photocurable ink in the present invention is therefore preferably a photocurable ink that can cure upon exposure to ultraviolet rays as radiation

(a) Polymerizable Compound

The photocurable ink (ink composition) of the present invention comprises (a) a polymerizable compound. Examples of the polymerizable compound that can be used in the present invention include a radically polymerizable compound and a cationically polymerizable compound. As the radically polymerizable compound, photocuring materials employing photopolymerizable compositions described in, for example, JP-A-7-159983, JP-B-7-31399, JP-A-8-224982, and JP-A-10-863 are known. As the cationically polymerizable compound, for example, a cationically polymerizable type photocuring resin is known, and in recent years cationically photopolymerizable type photocuring resins sensitized to a visible light wavelength region of 400 nm or longer have been disclosed in, for example, JP-A-6-43633 and JP-A-8-324137.

In the present invention, it is preferable to use a radically polymerizable compound as the polymerizable compound. The radically polymerizable compound is preferable as the polymerizable compound since curing sensitivity is high and curing speed is high.

It is therefore preferable in the present invention for the photocurable ink to be a radically polymerizable ink.

### Radically Polymerizable Compound

The radically polymerizable compound is a compound having a radically polymerizable ethylenically unsaturated bond, and may be any compound as long as it has at least one radically polymerizable ethylenically unsaturated bond in the molecule; examples thereof include those having a chemical configuration such as a monomer, an oligomer, or a polymer. One type of radically polymerizable compound may be used, or two or more types thereof may be used in combination in order to improve an intended property. Furthermore, it is preferable to use in combination a polyfunctional compound having two or more functional groups rather than a monofunctional compound being used on its own. Moreover, it is also preferable to use in combination two or more types of polyfunctional compounds from the viewpoint of control of aspects of performance such as reactivity and physical properties.

Examples of the polymerizable compound having a radically polymerizable ethylenically unsaturated bond include unsaturated carboxylic acids such as acrylic acid, methacrylic acid, itaconic acid, crotonoic acid, isocrotonoic acid, and maleic acid, and salts thereof, anhydrides having an ethylenically unsaturated group, acrylonitrile, styrene, and various types of radically polymerizable compounds such as unsaturated polyesters, unsaturated polyethers, unsaturated polyamides, and unsaturated urethanes.

Specific examples thereof include acrylic acid derivatives such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentylglycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylol acrylamide, diacetone acrylamide, and epoxyacrylate; methacrylic derivatives such as methyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane; and allyl compound derivatives such as allyl glycidyl ether, diallyl phthalate, and triallyl trimellitate. More specifically, commercial products, radically polymerizable or crosslinking monomers, oligomers, and polymers known in the art such as those described in ‘Kakyozai Handobukku’ (Crosslinking Agent Handbook), Ed. S. Yamashita (Taiseisha, 1981); ‘UV•EB Koka Handobukku’ (UV•EB Curing Handbook (Starting Materials) Ed. K. Kato (Kobunshi Kankoukai, 1985); ‘UV•EB Koka Gijutsu no Oyo to Shijyo’ (Application and Market of UV•EB Curing Technology’, p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) can be used.

Furthermore, in the present invention, the photocurable ink (ink composition) preferably comprises an N-vinyllactam as the radically polymerizable compound. Preferred examples of the N-vinyllactam include compounds represented by Formula (I) below.

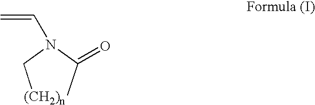

In Formula (I), n denotes an integer of 1 to 5; n is preferably an integer of 2 to 4 from the viewpoint of flexibility after the ink composition is cured, adhesion to a recording medium, and ease of availability of starting material, n is more preferably an integer of 2 or 4, and n is particularly preferably 4, which is N-vinyl-ε-caprolactam. N-vinyl-ε-caprolactam is preferable since it has excellent safety, is commonly used and easily available at a relatively low price, and gives particularly good ink curability and adhesion of a cured film to a recording medium.

The N-vinyllactam may have a substituent such as an alkyl group or an aryl group on the lactam ring, and may have a saturated or unsaturated ring structure bonded thereto.

In the present invention, the photocurable ink (ink composition) preferably comprises an N-vinyllactam at 10 wt % or greater of the entire photocurable ink (ink composition). It is preferable for an N-vinyllactam to be contained at 10 wt % or greater of the entire ink since it is possible to provide a photocurable ink (ink composition) that has excellent curability and gives a cured film having flexibility and adhesion to a substrate. The N-vinyllactam content in the photocurable ink (ink composition) is more preferably at least 10 wt % but no greater than 40 wt %. The N-vinyllactam is a compound having a relatively high melting point. It is preferable for the content of the N-vinyllactam to be no greater than 40 wt % since good solubility is exhibited at a low temperature of 0° C. or less and the temperature range in which the ink composition can be handled becomes large. The content is more preferably at least 12 wt % but no greater than 40 wt %, and particularly preferably at least 15 wt % but no greater than 35 wt %.

Only one type of N-vinyllactam may be contained in the ink composition, or a plurality of types thereof may be contained therein.

The ink washing liquid of the present invention may be used suitably as a washing liquid for a photocurable ink comprising an N-vinyllactam as a polymerizable compound. Since the N-vinyllactam is a solid monomer at room temperature, it easily causes problems such as precipitation; during washing the precipitation is often accelerated by contact with a washing liquid other than a specific washing liquid such as that of the present invention, and it is difficult to wash by a conventional washing liquid.

Use of the ink washing liquid of the present invention allows a photocurable ink comprising an N-vinyllactam as a polymerizable compound to be washed effectively.

### Cationically Polymerizable Compound

The cationically polymerizable compound used in the present invention is not particularly limited as long as it is a compound that undergoes a polymerization reaction by virtue of an acid generated by a cationic polymerization initiator (a photo-acid generator), which will be described later, and is cured, and various types of cationically polymerizable monomers known as photo-cationically polymerizable monomers may be used. Examples of the cationically polymerizable monomer include epoxy compounds, vinyl ether compounds, oxetane compounds described in JP-A-6-9714, JP-A-2001-31892, JP-A-2001-40068, JP-A-2001-55507, JP-A-2001-310938, JP-A-2001-310937, JP-A-2001-220526, etc.

Examples of the epoxy compounds include aromatic epoxides, alicyclic epoxides, and aliphatic epoxides, and examples of the aromatic epoxide include di- or polyglycidyl ethers produced by a reaction between epichlorohydrin and a polyhydric phenol having at least one aromatic nucleus or an alkylene oxide adduct thereof; specific examples include di- or polyglycidyl ethers of bisphenol A or an alkylene oxide adduct thereof, di- or polyglycidyl ethers of hydrogenated bisphenol A or an alkylene oxide adduct thereof, and novolac type epoxy resins. Examples of the alkylene oxide above include ethylene oxide and propylene oxide.

Preferred examples of the alicyclic epoxides include cyclohexene oxide- and cyclopentene oxide-containing compounds obtained by epoxidizing a compound having at least one cycloalkene ring such as a cyclohexene ring or a cyclopentene ring with an appropriate oxidizing agent such as hydrogen peroxide or a peracid.

Examples of the aliphatic epoxides include di- or polyglycidyl ethers of an aliphatic polyhydric alcohol or an alkylene oxide adduct thereof, and representative examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or triglycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

Detailed examples of monofunctional and polyfunctional epoxy compounds that can be used in the present invention are now given.

Examples of monofunctional epoxy compounds used in the present invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, 3-vinylcyclohexene oxide, and 4-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl-5,5-spiro-3,4-epoxy)cyclohexane-meta-dioxane, bis(3,4-epoxycyclohexylmethyl) adipate, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl) ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these epoxy compounds, the aromatic epoxides and the alicyclic epoxides are preferable from the viewpoint of excellent curing speed, and the alicyclic epoxides are particularly preferable.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether-O-propylene carbonate, dodecyl vinyl ether, and diethylene glycol monovinyl ether.

Detailed examples of monofunctional vinyl ethers and polyfunctional vinyl ethers are given below.

Specific examples of monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

The oxetane compound in the present invention means a compound having at least one oxetane ring, and may be selected freely from known oxetane compounds such as those described in JP-A-2001-220526, JP-A-2001-310937, and JP-A-2003-341217.

As the compound having an oxetane ring that can be used in the present invention, a compound having 1 to 4 oxetane rings in the structure is preferable. In accordance with use of such a compound, it becomes easy to maintain the viscosity of the ink composition in a range that gives good handling properties and, furthermore, the cured ink can be given high adhesion to the recording medium, which is preferable.

Examples of compounds having 1 to 2 oxetane rings in the molecule include compounds represented by Formulae (1) to (3) below.

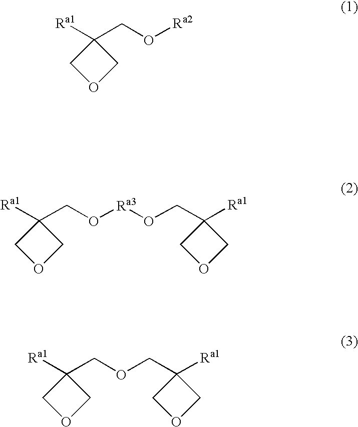

R^{a1} denotes a hydrogen atom, an alkyl group having 1 to 6 carbons, a fluoroalkyl group having 1 to 6 carbons, an allyl group, an aryl group, a furyl group, or a thienyl group. When there are two R^{a1} in the molecule, they may be identical to or different from each other.

Examples of the alkyl group include a methyl group, an ethyl group, a propyl group, and a butyl group, and preferred examples of the fluoroalkyl group include those obtained by substituting any of the hydrogen atoms of the above alkyl groups with a fluorine atom.

R^{a2} denotes a hydrogen atom, an alkyl group having 1 to 6 carbons, an alkenyl group having 2 to 6 carbons, a group having an aromatic ring, an alkylcarbonyl group having 2 to 6 carbons, an alkoxycarbonyl group having 2 to 6 carbons, or an N-alkylcarbamoyl group having 2 to 6 carbons. Examples of the alkyl group include a methyl group, an ethyl group, a propyl group, and a butyl group, examples of the alkenyl group include a 1-propenyl group, a 2-propenyl group, a 2-methyl-1-propenyl group, a 2-methyl-2-propenyl group, a 1-butenyl group, a 2-butenyl group, and a 3-butenyl group, and examples of the group having an aromatic ring include a phenyl group, a benzyl group, a fluorobenzyl group, a methoxybenzyl group, and a phenoxyethyl group. Examples of the alkylcarbonyl group include an ethylcarbonyl group, a propylcarbonyl group, and a butylcarbonyl group, examples of the alkoxycarbonyl group include an ethoxycarbonyl group, a propoxycarbonyl group, and a butoxycarbonyl group, and examples of the N-alkylcarbamoyl group include an ethylcarbamoyl group, a propylcarbamoyl group, a butylcarbamoyl group, and a pentylcarbamoyl group. Furthermore, it is possible for R² to have a subsituent, and the examples of the substituent include alkyl group, having 1 to 6 carbons and fluorine atom.

R^{a3} denotes a linear or branched alkylene group, a linear or branched poly(alkyleneoxy) group, a linear or branched unsaturated hydrocarbon group, a carbonyl group, a carbonyl group-containing alkylene group, a carboxyl group-containing alkylene group, a carbamoyl group-containing alkylene group, or a group shown below. Examples of the alkylene group include an ethylene group, a propylene group, and a butylene group, and examples of the poly(alkyleneoxy) group include a poly(ethyleneoxy) group and a poly(propyleneoxy) group. Examples of the unsaturated hydrocarbon group include a propenylene group, a methylpropenylene group, and a butenylene group.

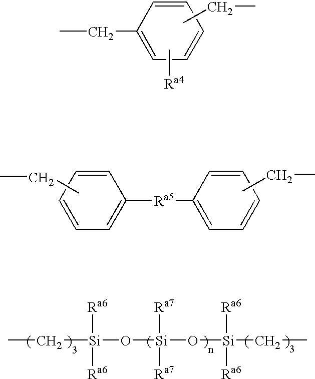

When R^{a3} is the above-mentioned polyvalent group, R^{a4} denotes a hydrogen atom, an alkyl group having 1 to 4 carbons, an alkoxy group having 1 to 4 carbons, a halogen atom, a nitro group, a cyano group, a mercapto group, a lower alkylcarboxyl group, a carboxyl group, or a carbamoyl group.

R^{a5} denotes an oxygen atom, a sulfur atom, a methylene group, NH, SO, SO₂, C(CF₃)₂, or, C(CH₃)₂.

R^{a6} denotes an alkyl group having 1 to 4 carbons or an aryl group, and n is an integer of 0 to 2,000. R^{a7} denotes an alkyl group having 1 to 4 carbons, an aryl group, or a monovalent group having the structure below. In the formula, R^{a8} denotes an alkyl group having 1 to 4 carbons or an aryl group, and m is an integer of 0 to 100.

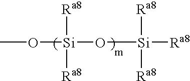

Examples of the compound represented by Formula (1) include 3-ethyl-3-hydroxymethyloxetane (OXT-101: manufactured by Toagosei Co., Ltd.), 3-ethyl-3-(2-ethylhexyloxymethyl)oxetane (OXT-212: manufactured by Toagosei Co., Ltd.), and 3-ethyl-3-phenoxymethyloxetane (OXT-211: manufactured by Toagosei Co., Ltd.). Examples of the compound represented by Formula (2) include 1,4-bis[(3-ethyl-3-oxetanylmethoxy)methyl]benzene (OXT-121: manufactured by Toagosei Co., Ltd.). Examples of the compound represented by Formula (3) include bis(3-ethyl-3-oxetanylmethyl) ether (OXT-221: manufactured by Toagosei Co., Ltd.).

Examples of the compound having 3 to 4 oxetane rings in the molecule include compounds represented by Formula (4) below.

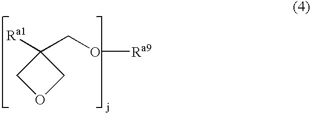

In Formula (4), R^{a1} denotes the same as in Formula (1) above. Furthermore, examples of R^{a9}, which is a polyvalent linking group, include a branched alkylene group having 1 to 12 carbons such as a group represented by A to C below, a branched poly(alkyleneoxy) group such as a group represented by D below, and a branched polysiloxane group such as a group represented by E below. j is 3 or 4.

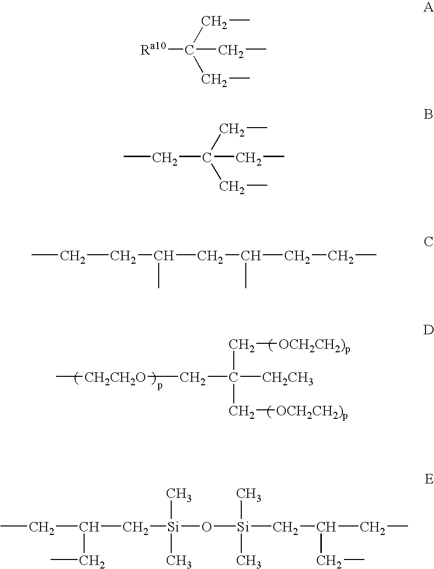

In the above A, R^{a10} denotes a methyl group, an ethyl group, or a propyl group. Furthermore, in the above D, p is an integer of 1 to 10.

Moreover, as another embodiment of the oxetane compound that can be suitably used in the present invention, a compound having an oxetane ring on a side chain, represented by Formula (5) below, can be cited.

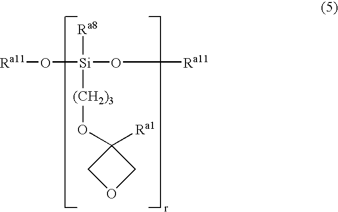

In Formula (5), R^{a1} and R^{a8} denote the same as in the above-mentioned formulae. R^{a11} is an alkyl group having 1 to 4 carbons such as a methyl group, an ethyl group, a propyl group, or a butyl group, or a trialkylsilyl group, and r is 1 to 4.

Such compounds having an oxetane ring are described in detail in paragraph Nos. [0021] to [0084] of JP-A-2003-341217 above, and the compounds described here may be suitably used in the present invention.

The oxetane compounds described in JP-A-2004-91556 can be used in the present invention. The details are described in paragraph Nos. [0022] to [0058].

Among the oxetane compounds used in the present invention, from the viewpoint of ink composition viscosity and tackiness, it is preferable to use a compound having one oxetane ring.

The ink composition of the present invention may comprise only one type of cationically polymerizable compound or two or more types thereof in combination, but from the viewpoint of suppressing effectively shrinkage during ink curing, it is preferable to use a combination of a vinyl ether compound and at least one type of compound selected from the oxetane compounds and the epoxy compounds.

The content of the cationically polymerizable compound in the ink composition is suitably in the range of 10 to 95 wt % relative to the total solids content of the composition, preferably 30 to 90 wt %, and more preferably 50 to 85 wt %.

### Preferred Polymerizable Compound

In the present invention, the ink composition preferably comprises an N-vinyllactam and another radically polymerizable compound as polymerizable compounds.

In the present invention, as the other radically polymerizable compound that is used in combination with the N-vinyllactam, a (meth)acrylic monomer or prepolymer, an epoxy monomer or prepolymer, an oxetane monomer or prepolymer, a urethane monomer or prepolymer, etc. are preferably used. More preferred compounds are as listed below.

2-Ethylhexyl-diglycol acrylate, 2-hydroxy-3-phenoxypropyl acrylate, 2-hydroxybutyl acrylate, neopentylglycol diacrylate hydroxypivalate, 2-acryloyloxyethylphthalic acid, methoxy-polyethyleneglycol acrylate, tetramethylolmethane triacrylate, 2-acryloyloxyethyl-2-hydroxyethylphthalic acid, dimethyloltricyclodecane diacrylate, ethoxylated phenylacrylate, 2-acryloyloxyethylsuccinic acid, nonylphenol ethylene oxide adduct acrylate, modified glycerol triacrylate, bisphenol A diglycigyl ether acrylic acid adduct, modified bisphenol A diacrylate, phenoxy-polyethylene glycol acrylate, 2-acryloyloxyethylhexahydrophthalic acid, bisphenol A propylene oxide modified diacrylate, bisphenol A ethylene oxide adduct diacrylate, dipentaerythritol hexaacrylate, pentaerythritol triacrylate tolylenediisocyanate urethane prepolymer, lactone modified flexible acrylate, butoxyethyl acrylate, propylene glycol digrycigyl ether acrylic acid adduct, pentaerythritol triacrylate hexametylenediisocyanate urethane prepolymer, 2-hydroxyethyl acrylate, methoxydipropylene grycol acrylate, ditrimetylolpropane tetraacrylate, pentaerythritol triacrylate hexametylenediisocyanate urethane prepolymer, stearyl acrylate, isoamyl acrylate, isomyristyl acrylate, isostearyl acrylate, etc.

These acrylate compounds can be reduced viscosity, can be obtained stable ink dischargability, and have high polymerizable sensitivity and good adhesion to a recording medium than a polymerizable compound having been used for conventional UV curing type ink, and that is preferable. In the present invention, when the above-mentioned acrylate compound is used as the polymerizable compound, the content of the acrylate compound is preferably 20 to 95 wt % of the entire weight of the ink composition, more preferably 30 to 95 wt %, and yet more preferably 40 to 95 wt %.

In the present invention, the above-mentioned monomer as a polymerizable compound has low sensitizing effect although it is a low molecular weight, high reactivity, low viscosity, and good adhesion to a recording medium.

Furthermore, in order to improve sensitivity, spreading, and adhesion to a recording medium, from the viewpoint of improving sensitivity and adhesion, it is preferable to use a combination of the above-mentioned monoacrylate and a polyfunctional acrylate monomer or a polyfunctional acrylate oligomer of molecular weight is at least 400, preferably at least 500. Furthermore, it is particularly preferable to use a combination of a monofunctional monomer, a difunctional monomer, and a polyfunctional monomer which is a trifunctional or more functional monomer. While maintaining safety, it can be improved sensitivity, spreading, and adhesion to a recording medium, which is preferable. A oligomer is particularly preferably a epoxy acrylate oligomer and a urethane oligomer.

In a recording to a flexible recording medium such as a PET film and a PP film, it is preferable to use a monoacrylate selected from the group consisting of the above-mentioned compounds and a polyfunctional acrylate monomer or a polyfunctional acrylate oligomer in combination in order to have flexibility of a membrane, improve adhesion, and improve strength of a membrane. The monoacrylate is preferably stearyl acrylate, isoamyl acrylate, isomyristyl acrylate or isostearyl acrylate from the viewpoint of high sensitivity, low shrinkage, suppressing curing, and preventing spreading, odor of a printed material, and cost-cutting of a irradiation device.

In the above-mentioned compounds, it is preferably to use less than 70 wt % of the content of an alcoxyacrylate and the other content of an acrylate in order to have high sensitivity, good spreading character, and good odor character.

(b) Polymerization Initiator

The ink composition of the present invention comprises (b) a polymerization initiator. As the polymerization initiator, a known radical polymerization initiator or cationic polymerization initiator (photo-acid generator) may be used. The polymerization initiators may be used singly or in a combination of two or more types.

The radical polymerization initiator or the cationic polymerization initiator that can be used in the ink composition of the present invention is a compound that forms a polymerization initiating species by absorbing external energy. The external energy used for initiating polymerization is roughly divided into heat and actinic radiation, and a thermal polymerization initiator and a photopolymerization initiator are used respectively. Examples of the actinic radiation include γ rays, β rays, an electron beam, UV rays, visible light, and IR rays.

### Radical Polymerization Initiator

Examples of the radical polymerization initiator that can be used in the present invention include (a) aromatic ketones, (b) aromatic onium salt compounds, (c) organic peroxides, (d) thio compounds, (e) hexaarylbiimidazole compounds, (f) ketoxime ester compounds, (g) borate compounds, (h) azinium compounds, (i) metallocene compounds, (j) active ester compounds, (k) compounds having a carbon-halogen bond, and (l) alkylamine compounds. These radical polymerization initiators may be used singly or in a combination of the above-mentioned compounds (a) to (l). The radical polymerization initiators of the present invention are suitably used singly or in a combination of two or more types.

### Cationic Polymerization Initiator

As the cationic polymerization initiator (photo-acid generator) that can be used in the present invention, for example, compounds that are used for chemically amplified photoresists or cationic photopolymerization are used (ref. ‘Imejingu yo Yukizairyou’ (Organic Materials for Imaging) Ed. The Japanese Research Association for Organic Electronics Materials, Bunshin Publishing Co. (1993), pp. 187-192). Examples of the cationic polymerization initiator suitably used in the present invention are listed below.

Firstly, B(C₆F₅)₄⁻, PF₆⁻, AsF₆⁻, SbF₆⁻, and CF₃SO₃⁻ salts of aromatic onium compounds such as diazonium, ammonium, iodonium, sulfonium, and phosphonium can be cited. Secondly, sulfonates that generate a sulfonic acid can be cited. Thirdly, halides that photogenerate a hydrogen halide can also be used. Fourthly, iron allene complexes can be cited.

(c) Coloring Agent

In the present invention the ink composition preferably comprises (c) a coloring agent.

The coloring agent that can be used in the present invention is not particularly limited, but a pigment and an oil-soluble dye that have excellent weather resistance and rich color reproduction are preferable, and it may be selected from any known coloring agent. It is preferable that the coloring agent that can be suitably used in the ink composition of the present invention does not function as a polymerization inhibitor in a polymerization reaction, which is a curing reaction. This is because the sensitivity of the curing reaction by actinic radiation should not be degraded.

### Pigment

The pigment is not particularly limited, and it is possible to use any generally commercially available organic pigment or inorganic pigment, a dispersion of a pigment in an insoluble resin, etc. as a dispersion medium, a pigment on the surface of which a resin has been grafted, etc. It is also possible to use resin particles colored with a dye, etc.

Examples of these pigments include pigments described in ‘Ganryo no Jiten’ (Dictionary of Pigments) Ed. by Seijirou Ito (2000), W. Herbst, K. Hunger ‘Industrial Organic Pigments’, JP-A-2002-12607, JP-A-2002-188025, JP-A-2003-26978, and JP-A-2003-342503.

Specific examples of the organic pigment and the inorganic pigment that can be used in the present invention include, as those exhibiting a yellow color, monoazo pigments such as CI Pigment Yellow 1 (Fast Yellow G, etc.) and Cl Pigment Yellow 74, disazo pigments such as CI Pigment Yellow 12 (Disazo Yellow AAA, etc.) and CI Pigment Yellow 17, benzidine-free azo pigments such as CI Pigment Yellow 180, azo lake pigments such as CI Pigment Yellow 100 (Tartrazine Yellow Lake, etc.), condensed azo pigments such as CI Pigment Yellow 95 (Azo Condensation Yellow GR, etc.), acidic dye lake pigments such as CI Pigment Yellow 115 (Quinoline Yellow Lake, etc.), basic dye lake pigments such as Cl Pigment Yellow 18 (Thioflavine Lake, etc.), anthraquinone pigments such as Flavanthrone Yellow (Y-24), isoindolinone pigments such as Isoindolinone Yellow 3RLT (Y-110), quinophthalone pigments such as Quinophthalone Yellow (Y-138), isoindoline pigments such as Isoindoline Yellow (Y-139), nitroso pigments such as CI Pigment Yellow 153 (Nickel Nitroso Yellow, etc.), and metal complex azomethine pigments such as CI Pigment Yellow 117 (Copper Azomethine Yellow, etc.).

Examples of pigments exhibiting a red or magenta color include monoazo pigments such as CI Pigment Red 3 (Toluidine Red, etc.), disazo pigments such as CI Pigment Red 38 (Pyrazolone Red B, etc.), azo lake pigments such as Cl Pigment Red 53:1 (Lake Red C, etc.) and CI Pigment Red 57:1 (Brilliant Carmine 6B), condensed azo pigments such as CI Pigment Red 144 (Azo Condensation Red BR, etc.), acidic dye lake pigments such as CI Pigment Red 174 (Phloxine B Lake, etc.), basic dye lake pigments such as CI Pigment Red 81 (Rhodamine 6G′ Lake, etc.), anthraquinone pigments such as CI Pigment Red 177 (Dianthraquinonyl Red, etc.), thioindigo pigments such as CI Pigment Red 88 (Thioindigo Bordeaux, etc.), perinone pigments such as CI Pigment Red 194 (Perinone Red, etc.), perylene pigments such as CI Pigment Red 149 (Perylene Scarlet, etc.), quinacridone pigments such as CI Pigment violet 19 (unsubstituted quinachridone) and CI Pigment Red 122 (Quinacridone Magenta, etc.), isoindolinone pigments such as CI Pigment Red 180 (Isoindolinone Red 2BLT, etc.), and alizarin lake pigments such as CI Pigment Red 83 (Madder Lake, etc.).

Examples of pigments exhibiting a blue or cyan color include disazo pigments such as CI Pigment Blue 25 (Dianisidine Blue, etc.), phthalocyanine pigments such as CI Pigment Blue 15 (Phthalocyanine Blue, etc.) and CI Pigment Blue 15:3, acidic dye lake pigments such as CI Pigment Blue 24 (Peacock Blue Lake, etc.), basic dye lake pigments such as CI Pigment Blue 1 (Victoria Pure Blue BO Lake, etc.), anthraquinone pigments such as CI Pigment Blue 60 (Indanthrone Blue, etc.), and alkali blue pigments such as CI Pigment Blue 18 (Alkali Blue V-5:1).

Examples of pigments exhibiting a green color include phthalocyanine pigments such as CI Pigment Green 7 (Phthalocyanine Green) and CI Pigment Green 36 (Phthalocyanine Green), and azo metal complex pigments such as Cl Pigment Green 8 (Nitroso Green).

Examples of pigments exhibiting an orange color include isoindoline pigments such as CI Pigment Orange 66 (Isoindoline Orange) and anthraquinone pigments such as CI Pigment Orange 51 (Dichloropyranthrone Orange).

Examples of pigments exhibiting a black color include carbon black (Pigment Black 7), titanium black, and aniline black.

Specific examples of white pigments that can be used include basic lead carbonate (2PbCO₃Pb(OH)₂, also known as silver white), zinc oxide (ZnO, also known as zinc white), titanium oxide (TiO₂, also known as titanium white), and strontium titanate (SrTiO₃, also known as titan strontium white).

Titanium oxide has, compared with other white pigments, a low specific gravity, a high refractive index, and is chemically and physically stable, and therefore has high hiding power and coloring power as a pigment and, furthermore, has excellent durability toward acids, alkalis, and other environments. It is therefore preferable to use titanium oxide as the white pigment. It is of course possible to use another white pigment (which can be any white pigment, in addition to the white pigments cited above) as necessary.

For dispersion of the pigment, for example, a dispersing machine such as a ball mill, a sand mill, an attritor, a roll mill, a jet mill, a homogenizer, a paint shaker, a kneader, an agitator, a Henschel mixer, a colloidal mill, an ultrasonic homogenizer, a pearl mill, or a wet type jet mill may be used.

When carrying out dispersion of the pigment, a dispersant may be added. Examples of the dispersant include hydroxyl group-containing carboxylic acid esters, salts of a long-chain polyaminoamide and a high molecular weight acid ester, high molecular weight polycarboxylic acid salts, high molecular weight unsaturated acid esters, high molecular weight copolymers, modified polyacrylates, aliphatic polycarboxylic acids, naphthalenesulfonic acid formaldehyde condensates, polyoxyethylene alkylphosphate esters, and pigment derivatives. It is also preferable to use a commercial polymeric dispersant such as the Solsperse series manufactured by Zeneca.

Furthermore, as a dispersion adjuvant, it is also possible to use a synergist, depending on the various types of pigment. The dispersant and dispersion adjuvant are preferably used at 1 to 50 parts by weight relative to 100 parts by weight of the pigment.

In the ink composition, as a dispersing medium for various components such as the pigment, a solvent may be added, or the polymerizable compound (a), which is a low molecular weight compound, may be used as a dispersing medium without using a solvent, and since, in the present invention, the ink composition is a radiation curing type ink, and after the ink is applied on top of a recording medium it is cured, it is preferable not to use a solvent. This is because, if a solvent remains in the cured ink image, the solvent resistance is degraded and the VOC (Volatile Organic Compound) problem of the residual solvent occurs. From this viewpoint, it is preferable to use as a dispersing medium the polymerizable compound (a) and, in particular, it is preferable to select a polymerizable monomer having the lowest viscosity in terms of improvement of dispersion suitability and handling properties of the ink composition.

It is preferable for the average particle size of the pigment to be in the range of 0.02 to 0.4 μm, more preferably 0.02 to 0.1 μm, and yet more preferably, 0.02 to 0.07 μm.

In order to make the average particle size of the pigment particles be in the above-mentioned range, the pigment, the dispersant, and the dispersing medium are selected, and dispersion conditions and filtration conditions are set. By such control of particle size, clogging of a head nozzle can be suppressed, and the storage stability of ink, the ink transparency, and the curing sensitivity can be maintained.

It is preferable to add the colorant at 1 to 20 wt % on a solids content basis of the ink composition, and more preferably 2 to 10 wt %.

(d) Sensitizing Dye

The ink composition of the present invention may contain a sensitizing dye in order to promote decomposition of the above-mentioned polymerization initiator by absorbing specific actinic radiation. The sensitizing dye absorbs specific actinic radiation and attains an electronically excited state. The sensitizing dye in the electronically excited state causes actions such as electron transfer, energy transfer, or heat generation upon contact with the polymerization initiator. This causes the polymerization initiator to undergo a chemical change and decompose, thus forming a radical, an acid, or a base.

Preferred examples of the sensitizing dye include those that belong to compounds below and have an adsorption wavelength in the region of 350 nm to 450 nm.

Polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavin, acriflavine), anthraquinones (e.g. anthraquinone), squaryliums (e.g. squarylium), and coumarins (e.g. 7-diethylamino-4-methylcoumarin).

Preferred examples of the sensitizing dye include compounds represented by Formulae (IX) to (XIII) below.

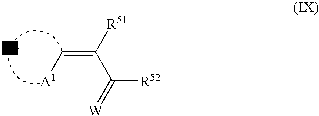

In Formula (IX), A¹ denotes a sulfur atom or NR⁵⁰, R⁵⁰ denotes an alkyl group or an aryl group, L² denotes a non-metallic atomic group forming a basic nucleus of a dye in cooperation with a neighboring A¹ and the neighboring carbon atom, R⁵¹ and R⁵² independently denote a hydrogen atom or a monovalent non-metallic atomic group, and R⁵¹ and R⁵² may be bonded together to form an acidic nucleus of a dye. W denotes an oxygen atom or a sulfur atom.

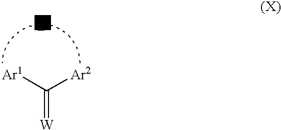

In Formula (X), Ar¹ and Ar² independently denote an aryl group and are connected to each other via a bond of -L³-. Here, L³ denotes —O— or —S—. W has the same meaning as that shown in Formula (IX)

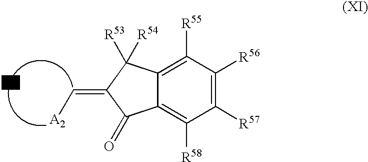

In Formula (XI), A₂ denotes a sulfur atom or NR⁵⁹, L⁴ denotes a non-metallic atomic group forming a basic nucleus of a dye in cooperation with the neighboring A₂ and carbon atom, R⁵³, R⁵⁴, R⁵⁵, R⁵⁶, R⁵⁷, and R⁵⁸ independently denote a monovalent non-metallic atomic group, and R⁵⁹ denotes an alkyl group or an aryl group.

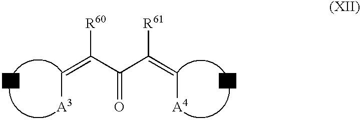

In Formula (XII), A³ and A⁴ independently denote —S—, —NR⁶²—, or —NR⁶³—, R⁶² and R⁶³ independently denote a substituted or unsubstituted alkyl group, or a substituted or unsubstituted aryl group, L⁵ and L⁶ independently denote a non-metallic atomic group forming a basic nucleus of a dye in cooperation with the neighboring A³ and A⁴ and neighboring carbon atom, and R⁶⁰ and R⁶¹ independently denote a hydrogen atom or a monovalent non-metallic atomic group, or are bonded to each other to form an aliphatic or aromatic ring.

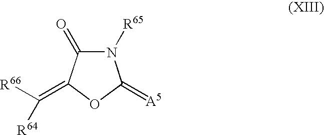

In Formula (XIII), R⁶⁶ denotes an aromatic ring or a hetero ring, which may have a substituent, and A⁵ denotes an oxygen atom, a sulfur atom, or —NR⁶⁷—. R⁶⁴, R⁶⁵, and R⁶⁷ independently denote a hydrogen atom or a monovalent non-metallic atomic group, and R⁶⁷ and R⁶⁴, and R⁶⁵ and R⁶⁷ may be bonded to each other to form an aliphatic or aromatic ring.

Specific examples of the compounds represented by Formulae (IX) to (XIII) include (E-1) to (E-20) listed below.

In some of the compound examples below, the hydrocarbon chain is described by a simplified structural formula in which symbols for carbon (C) and hydrogen (H) are omitted.

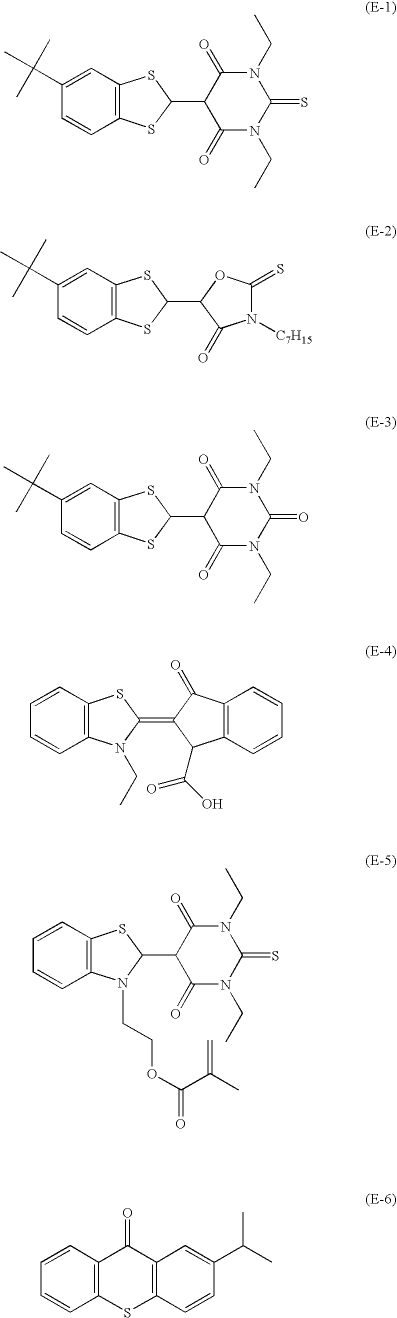

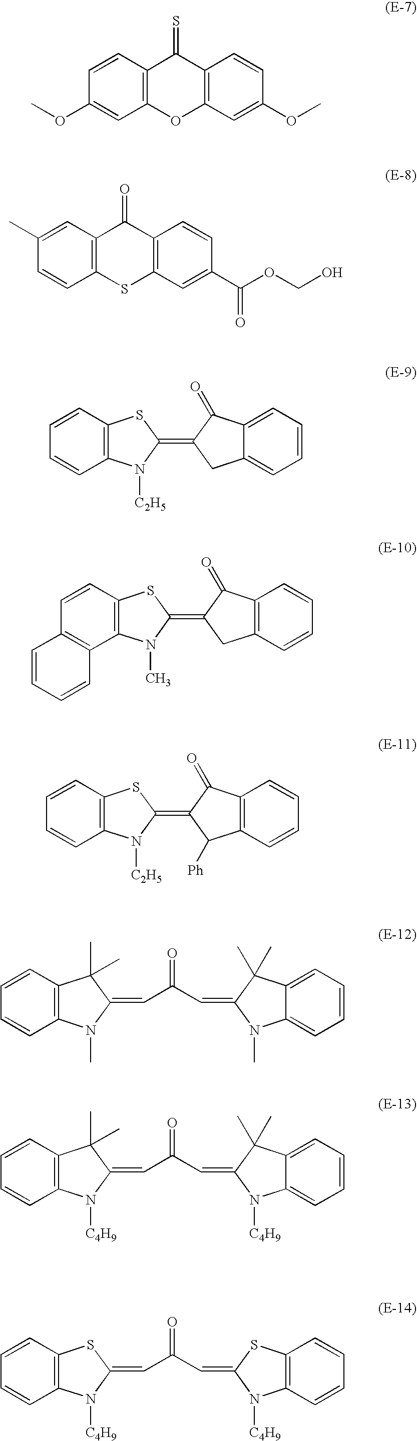

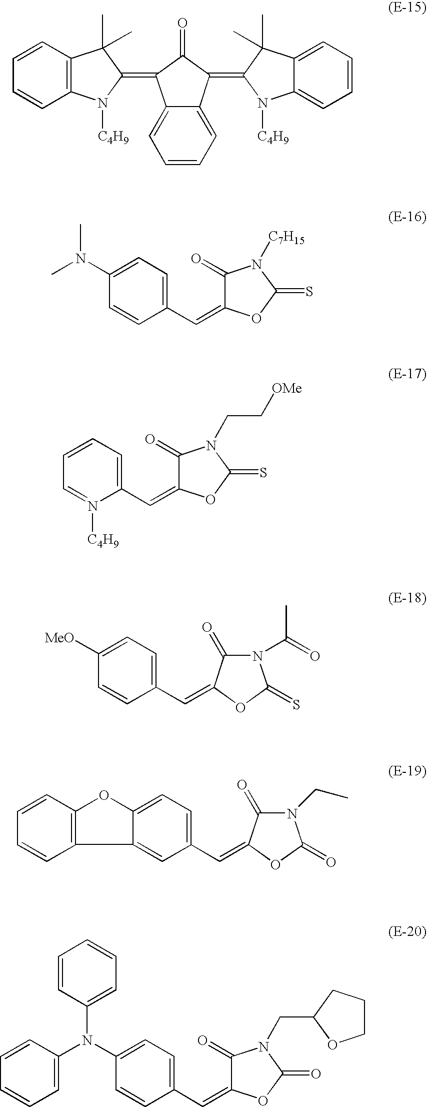

The amount thereof added is appropriately selected according to the intended application, and it is generally on the order of 0.1 to 20 wt % on the basis of the solids content in the ink composition.

(e) Cosensitizer

The ink composition of the present invention preferably comprises a cosensitizer. In the present invention, the cosensitizer has the function of further improving the sensitivity of the sensitizing dye to actinic radiation or the function of suppressing inhibition by oxygen of polymerization of a polymerizable compound, etc.

Examples of such a cosensitizer include amines such as compounds described in M. R. Sander et al., ‘Journal of Polymer Society’, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure No. 33825, and specific examples thereof include triethanolamine, ethyl p-dimethylaminobenzoate, p-formyldimethylaniline, and p-methylthiodimethylaniline.

Other examples of the cosensitizer include thiols and sulfides such as thiol compounds described in JP-A-53-702, JP-B-55-500806, and JP-A-5-142772, and disulfide compounds of JP-A-56-75643, and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the cosensitizer include amino acid compounds (e.g. N-phenylglycine, etc.), organometallic compounds described in JP-B-48-42965 (e.g. tributyltin acetate, etc.), hydrogen-donating compounds described in JP-B-55-34414, sulfur compounds described in JP-A-6-308727 (e.g. trithiane, etc.), and phosphorus compounds described in JP-A-6-250387 (diethylphosphite, etc.).

The amount thereof added is appropriately selected according to the intended application, and it is generally on the order of 0.1 to 20 wt % on the basis of the solids content in the ink composition.

(f) Other Components

The ink composition of the present invention may comprise another component as necessary. Examples of the other component include a UV absorber, an antioxidant, an antifading agent, a conductive salt, a solvent, a polymer compound, a surfactant and a basic compound.

### UV Absorber

A UV absorber may be used from the viewpoint of improving the weather resistance of an image obtained and preventing discoloration.

The UV absorbers include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106; triazine compounds described in JP-A-4-298503, JP-A-8-53427, JP-A-8-239368, JP-A-10-182621 and JP-W-8-501291 (the term “JP-W” as used herein means an unexamined published international patent application); compounds described in Research Disclosure No. 24239; and compounds represented by stilbene and benzoxazole compounds, which absorb ultraviolet rays to emit fluorescence, the so-called fluorescent brightening agents.

The amount thereof added is appropriately selected according to the intended application, and it is generally on the order of 0.5 to 15 wt % on the basis of the solids content in the ink composition.

### Antioxidant

In order to improve the stability of the ink composition, an antioxidant may be added. Examples of the antioxidant include those described in Laid-open European Patent Nos. 223739, 309401, 309402, 310551, 310552, and 459416, Laid-open German Patent No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount thereof added is appropriately selected according to the intended application, and it is generally on the order of 0.1 to 8 wt % on the basis of the solids content in the ink composition.

### Antifading Agent

The ink composition of the present invention may employ various organic and metal complex antifading agents. The organic antifading agents include hydroquinones, alkoxyphenols, dialkoxyphenols, phenols, anilines, amines, indanes, chromans, alkoxyanilines, and heterocycles, and the metal complex antifading agents include nickel complexes and zinc complexes. More specifically, there can be used compounds described in patents cited in Research Disclosure, No. 17643, Items VII-1 to J, ibid., No. 15162, ibid., No. 18716, page 650, left-hand column, ibid., No. 36544, page 527, ibid., No. 307105, page 872, and ibid., No. 15162, and compounds contained in general formulae and compound examples of typical compounds described in JP-A-62-21572, pages 127 to 137.

The amount thereof added is appropriately selected according to the intended application, and it is generally on the order of 0.1 to 8 wt % on the basis of the solids content in the ink composition.

### Conductive Salt

The ink composition of the present invention may contain, for the purpose of controlling discharge properties, a conductive salt such as potassium thiocyanate, lithium nitrate, ammonium thiocyanate, or dimethylamine hydrochloride.

### Solvent

It is also effective to add a trace amount of organic solvent to the ink composition of the present invention in order to improve the adhesion to a recording medium.

Examples of the solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorine-based solvents such as chloroform and methylene chloride, aromatic-based solvents such as benzene and toluene, ester-based solvents such as ethyl acetate, butyl acetate, and isopropyl acetate, ether-based solvents such as diethyl ether, tetrahydrofuran, and dioxane, and glycol ether-based solvents such as ethylene glycol monomethyl ether and ethylene glycol dimethyl ether.

In this case, it is effective if the amount thereof added is in a range that does not cause problems with the solvent resistance or the VOC, and the amount is preferably in the range of 0.1 to 5 wt % relative to the total amount of the ink composition, and more preferably 0.1 to 3 wt %.

### High Molecular Weight Compound

The ink composition may contain various types of high molecular weight compounds in order to adjust film physical properties. Examples of the high molecular weight compounds include acrylic polymers, polyvinylbutyral resins, polyurethane resins, polyamide resins, polyester resins, epoxy resins, phenol resins, polycarbonate resins, polyvinylformal resins, shellac, vinylic resins, acrylic resins, rubber-based resins, waxes, and other natural resins. They may be used in a combination of two or more types. Among these, a vinylic copolymer obtained by copolymerization of an acrylic monomer is preferable. Furthermore, as a copolymer component of the high molecular weight compound, a copolymer containing as a structural unit a ‘carboxyl group-containing monomer’, an ‘alkyl methacrylate ester’, or an ‘alkyl acrylate ester’ may preferably be used.

### Surfactant

As a surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl allyl ethers, acetylene glycols, and polyoxyethylene/polyoxypropylene block copolymers, and cationic surfactants such as alkylamine salts and quaternary ammonium salts. Instead of the surfactant, an organofluoro compound may be used. The organofluoro compound is preferably hydrophobic. Examples of the organofluoro compound include fluorine-based surfactants, oil-like fluorine-based compounds (e.g. a fluorine oil), and solid fluorine compounds resin (e.g. tetrafluoroethylene resin), and those described in JP-B-57-9053 (8th to 17th columns) and JP-A-62-135826.

### Basic Compound

It is preferable to add the basic compound from the viewpoint of improving the storage stability of the ink composition. As the basic compound that can be used in the present invention, a known basic compound may be used and, for example, a basic inorganic compound such as an inorganic salt or a basic organic compound such as an amine is preferably used.

In addition to the above, the composition may contain as necessary, for example, a leveling additive, a matting agent, a wax for adjusting film physical properties, or a tackifier in order to improve the adhesion to a recording medium such as polyolefin or PET, the tackifier not inhibiting polymerization.

Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

(3) Properties of Photocurable Ink (Ink Composition)

In the present invention the photocurable ink (ink composition) essentially contains a polymerizable compound (a) and a polymerization initiator (b), and may contain, as necessary, a coloring agent (c) as described above. With regard to these components, relative to the total weight of the ink composition, the polymerizable compound (a) is preferably 20 to 90 wt %, and more preferably 30 to 80 wt %, the polymerization initiator (b) is preferably 0.1 to 30 wt %, and more preferably 0.5 to 20 wt %, when the ink composition contains the coloring agent, the coloring agent is preferably 1 to 10 wt %, and more preferably 2 to 8 wt %, and each component is contained so that the total of each component expressed as wt % desirably becomes 100 wt %.

When the photocurable ink (ink composition) thus obtained is used for inkjet recording, while taking into consideration dischargability, the viscosity of the ink composition at the discharge temperature (e.g. 25° C. to 80° C., and preferably 25° C. to 50° C.) is preferably 7 to 30 mPa·s, and more preferably 7 to 20 mPa·s. For example, in the present invention the ink composition has a viscosity at room temperature (25° C. to 30° C.) of preferably 35 to 500 mPa·s, and more preferably 35 to 200 mPa·s. In the present invention with regard to the ink composition, it is preferable that its component ratio is appropriately adjusted so that the viscosity is in the above-mentioned range. When the viscosity at room temperature is set to be high, even when a porous recording medium is used, penetration of the ink into the recording medium can be prevented, uncured monomer can be reduced, and the odor can be reduced. Furthermore, ink spreading when ink droplets have landed can be suppressed, and as a result there is the advantage that the image quality is improved.

In the present invention the surface tension of the ink composition is preferably 20 to 30 mN/m, and yet more preferably 23 to 28 mN/m. When recording is carried out on various types of recording medium such as polyolefin, PET, coated paper, and uncoated paper, from the viewpoint of spread and penetration, it is preferably at least 20 mN/m, and from the viewpoint of wettability it is preferably not more than 30 mN/m.

### (4) Inkjet Recording Method and Equipment

In the present invention the photocurable ink (ink composition) is preferably used for inkjet recording.

An inkjet recording method that can be suitably employed in the present invention is explained below.

### (4-1) Inkjet Recording Method

In the present invention, as an inkjet recording method, there can be cited as an example a method in which a photocurable ink is discharged onto a recording medium (a support, a recording material, etc.), and the ink composition discharged onto the recording medium is irradiated with actinic radiation to thus cure the ink to form an image. That is, there can be cited as an example an inkjet recording method comprising

(a) a step of discharging a photocurable ink (ink composition) onto a recording medium, and

(b) a step of curing the photocurable ink (ink composition) by irradiating the discharged photocurable ink (ink composition) with actinic radiation.

The peak wavelength of the actinic radiation is preferably 200 to 600 nm, more preferably 300 to 450 nm, and yet more preferably 350 to 420 nm. The output of the actinic radiation is preferably no greater than 2,000 mJ/cm², and is more preferably 10 to 2,000 mJ/cm², yet more preferably 20 to 1,000 mJ/cm², and particularly preferably 50 to 800 mJ/cm².

### (4-1-1) Step of Discharging Photocurable Ink (Ink Composition) onto Recording Medium

In the present invention, when the photodcurable ink (ink composition) is discharged onto the surface of the recording medium, the photocurable ink (ink composition) is preferably discharged after being heated to preferably 25° C. to 80° C., and more preferably 25° C. to 50° C., so as to reduce the viscosity of the ink composition to preferably 7 to 30 mPa·s, and more preferably 7 to 20 mPa·s. In particular, it is preferable to use the ink composition having an ink viscosity at 25° C. of 35 to 500 mPa·s since a large effect can be obtained. By employing this method, high discharge stability can be realized. The radiation curing type ink composition such as the ink composition used in the present invention generally has a viscosity that is higher than that of a normal ink composition or a water-based ink used for an inkjet recording ink, and variation in viscosity due to a change in temperature at the time of discharge is large. Viscosity variation in the ink has a large effect on changes in liquid droplet size and changes in liquid droplet discharge speed and, consequently, causes the image quality to be degraded. It is therefore necessary to maintain the ink discharge temperature as constant as possible. In the present invention, the control range for the temperature is desirably ±5° C. of a set temperature, preferably ±2° C. of the set temperature, and more preferably ±1° C. of the set temperature.

### (4-1-2) Step of Curing Photocurable Ink (Ink Composition) by Irradiating Discharged Photocurable Ink (Ink Composition) with Actinic Radiation

The photocurable ink (ink composition) discharged onto the surface of the recording medium is cured by irradiating with actinic radiation. This results from a sensitizing dye in a polymerization initiation system contained in the above-mentioned ink composition of the present invention absorbing actinic radiation, attaining an excited state, and coming into contact with a polymerization initiator in the polymerization initiation system to thus decompose the polymerization initiator, and a polymerizable compound undergoing radical polymerization and being cured.

The actinic radiation used in this process may include α rays, γ rays, an electron beam, X rays, UV rays, visible light, and IR rays. Although it depends on the absorption characteristics of the sensitizing dye, the peak wavelength of the actinic radiation is, for example, 200 to 600 nm, preferably 300 to 450 nm, and more preferably 350 to 450 nm. Furthermore, in the present invention, the polymerization initiation system has sufficient sensitivity for low output actinic radiation. The output of the actinic radiation as irradiation energy is therefore, for example, 2,000 mJ/cm² or less, and is preferably 10 to 2,000 mJ/cm², more preferably 20 to 1,000 mJ/cm², and yet more preferably 50 to 800 mJ/cm². Moreover, the actinic radiation is applied so that the illumination intensity on the exposed surface is, for example, 10 to 2,000 mW/cm², and preferably 20 to 1,000 mW/cm².

The ink composition of the present invention is desirably exposed to such actinic radiation for, for example, 0.01 to 120 sec., and preferably 0.1 to 90 sec.

Irradiation conditions and a basic method for irradiation with actinic radiation are disclosed in JP-A-60-132767. Specifically, a light source is provided on either side of a head unit that includes an ink discharge device, and the head unit and the light source are made to scan by a so-called shuttle system. Irradiation with actinic radiation is carried out after a certain time (e.g. 0.01 to 0.5 sec., preferably 0.01 to 0.3 sec., and more preferably 0.01 to 0.15 sec.) has elapsed from when the ink has landed. By controlling the time from ink landing to irradiation so as to be a minimum in this way, it becomes possible to prevent the ink that has landed on a recording medium from spreading before being cured. Furthermore, since the ink can be exposed before it reaches a deep area of a porous recording medium that the light source cannot reach, it is possible to prevent monomer from remaining unreacted, and as a result the odor can be reduced.

Furthermore, curing may be completed using another light source that is not driven. WO99/54415 discloses, as an irradiation method, a method employing an optical fiber and a method in which a collimated light source is incident on a mirror surface provided on a head unit side face, and a recorded area is irradiated with UV light.

By employing such a recording method, it is possible to maintain a uniform dot diameter for landed ink even for various types of recording media having different surface wettability, thereby improving the image quality. In order to obtain a color image, it is preferable to superimpose colors in order from those with a low lightness. By superimposing inks in order from one with low lightness, it is easy for radiation to reach a lower ink, the curing sensitivity is good, the amount of residual monomer decreases, odor is reduced, and an improvement in adhesion can be expected. Furthermore, although it is possible to discharge all colors and then expose them at the same time, it is preferable to expose one color at a time from the viewpoint of promoting curing.

In this way, in the present invention the above-mentioned ink composition is cured by irradiation with actinic radiation to thus form an image on the surface of the recording medium.

### (4-2) Inkjet Recording Device

The inkjet recording device used in the present invention is not particularly restricted, and a commercial inkjet recording device may be used. That is, in the present invention, recording on a recording medium may be carried out using a commercial inkjet recording device.

The inkjet recording device that can be used in the present invention is equipped with, for example, an ink supply system, a temperature sensor, and an actinic radiation source.

The ink supply comprises, for example, a main tank containing the above-mentioned photocurable ink (ink composition), a supply pipe, an ink supply tank immediately before an inkjet head, a filter, and a piezo system inkjet head. The piezo system inkjet head may be driven so as to discharge a multisize dot of 1 to 100 pL, and preferably 8 to 30 pL, at a resolution of 320×320 to 4,000×4,000 dpi, preferably 400×400 to 1,600×1,600 dpi, and more preferably 720×720 dpi. Here, dpi referred to in the present invention means the number of dots per 2.54 cm.

As described above, since it is desirable for the radiation curing type ink to be discharged at a constant temperature, a section from the ink supply tank to the inkjet head is thermally insulated and heated. A method of controlling temperature is not particularly limited, but it is preferable to provide, for example, temperature sensors at a plurality of pipe section positions, and control heating according to the ink flow rate and the temperature of the surroundings. The temperature sensors may be provided on the ink supply tank and in the vicinity of the inkjet head nozzle. Furthermore, the head unit that is to be heated is preferably thermally shielded or insulated so that the device main body is not influenced by the temperature of the outside air. In order to reduce the printer start-up time required for heating, or in order to reduce the thermal energy loss, it is preferable to thermally insulate the head unit from other sections and also to reduce the heat capacity of the entire heated unit.

As an actinic radiation source, a mercury lamp, a gas/solid laser, etc. are mainly used, and for UV photocuring inkjet a mercury lamp and a metal halide lamp are widely known. However, from the viewpoint of protection of the environment, there has recently been a strong desire for mercury not to be used, and replacement by a GaN semiconductor UV light emitting device is very useful from industrial and environmental viewpoints. Furthermore, LEDs (UV-LED) and LDs (UV-LD) have small dimensions, long life, high efficiency, and low cost, and their use as a photocuring inkjet light source can be expected.

Furthermore, light-emitting diodes (LED) and laser diodes (LD) may be used as the source of actinic radiation. In particular, when a UV ray source is needed, a UV-LED or a UV-LD may be used. For example, Nichia Corporation has marketed a violet LED having a wavelength of the main emission spectrum of between 365 nm and 420 nm. Furthermore, when a shorter wavelength is needed, U.S. Pat. No. 6,084,250 discloses an LED that can emit actinic radiation whose wavelength is centered between 300 nm and 370 nm. Furthermore, another UV LED is available, and irradiation can be carried out with radiation of a different UV bandwidth. The actinic radiation source particularly preferable in the present invention is a UV-LED, and a UV-LED having a peak wavelength at 350 to 420 nm is particularly preferable.

The maximum illumination intensity of the LED on a recording medium is preferably 10 to 2,000 mW/cm², more preferably 20 to 1,000 mW/cm², and particularly preferably 50 to 800 mJ/cm².

A cleaning method for an inkjet printer is now explained. An inkjet printer or some of the components thereof are cleaned using the ink washing liquid of the present invention. As a cleaning method, there is a method in which the inkjet printer or the component thereof is wiped with a cloth or a cleaning blade wetted with the ink washing liquid of the present invention, a method in which the inkjet printer or the component thereof is immersed in the ink washing liquid of the present invention, a method in which the inkjet printer or the component thereof is coated with the ink washing liquid of the present invention, and the washing liquid is then absorbed with an absorbing material by contacting the absorbing material with the inkjet printer or the component thereof, or a method in which the inkjet printer or the component thereof is coated with the ink washing liquid of the present invention, and the washing liquid is removed by subjecting the inkjet printer or the component thereof to air suction, air charging, etc.

Furthermore, when an inkjet printer is equipped with a cleaning mechanism in which a head of the inkjet printer is cleaned with a washing liquid, by supplying the ink washing liquid of the present invention to the cleaning mechanism, the head is cleaned by the cleaning mechanism. Moreover, when a discharge orifice of a head is covered with a cap, a cap that has been coated with the ink washing liquid of the present invention may be used.

Furthermore, the interior of a head of an inkjet printer is filled with the ink washing liquid of the present invention, and by discharging the ink washing liquid from the head and a nozzle, the interior of the head and the vicinity of the nozzle may be cleaned. In this case, it is preferable to apply a pressure of about 1 kPa to 100 kPa; specifically, the washing liquid is fed to the interior of the head via an ink supply path connected to the head. This process may comprise discharging the washing liquid via the nozzle by adjusting the pressure, or forcibly withdrawing the charged washing liquid from a nozzle face by means of a rubber tube, etc. without damaging the nozzle face. In some cases, the ink washing liquid may be discharged by driving the printer head in the same operation as for ink discharge.

As another example, there is a method in which the ink washing liquid is circulated so as to clean the interior of a printer (a nozzle, a head, a tube, a pump, etc.).

Alternatively, the interior of the head may be filled with the washing liquid, dissolution of solids within the head is accelerated by applying external vibration by means of ultrasonic waves, and the washing liquid is then discharged or recovered.

In the present invention, as a method for using an inkjet recording device, when the inkjet recording device is not used for a few hours it is preferable to fill the interior of the head of the inkjet printer with the ink washing liquid of the present invention. It is preferable to fill the interior of the head with the ink washing liquid of the present invention in this way since curing of the photocurable ink can be prevented, and clogging of the head can be suppressed.

Furthermore, when discharging has not been carried out for a certain time (preferably 12 to 168 hours, and more preferably 24 to 36 hours), it is preferable to automatically clean the head with the ink washing liquid, and it is more preferable to fill the cleaned head with the ink washing liquid. When it is used, the charged ink washing liquid is discharged or recovered to thus enable a photocurable ink to be discharged.

In accordance with the present invention, there can be provided an ink washing liquid for a photocurable ink and a cleaning method for an inkjet printer, the ink washing liquid having excellent cleaning properties for the photocurable ink. In particular, the ink washing liquid of the present invention is suitable for washing a radically polymerizable photocurable ink.

### EXAMPLES

The present invention is explained more specifically by reference to Examples and Comparative Examples. However, the present invention should not be construed as being limited to these Examples.

‘Parts’ described below means ‘parts by weight’ unless otherwise specified.

Cromophtal Yellow LA, Cinquasia Magenta RT-355D, Irgalite Blue GLVO, Microlith Black C-K, and Irgacure 184 used in the present invention are commercial products from Ciba Specialty Chemicals (CSC).

The Examples below relate to UV inkjet inks of each color.

### Example 1

Preparation of Radically Polymerizable Inks

### Yellow Ink 1

| | |
|---|---|
| N-Vinyl-ε-caprolactam (manufactured by Aldrich) | 25.0 parts |
| Actilane 421 | 29.4 parts |
| (polyfunctional acrylate monomer manufactured by Akcros) | |
| Photomer 4017 | 10.0 parts |
| (1,6-hexanediol diacrylate, UV diluent | |
| manufactured by EChem) | |
| Solsperse 32000 (dispersant manufactured by Noveon) | 0.4 parts |
| Cromophtal Yellow LA (pigment manufactured by CSC) | 3.6 parts |
| Genorad 16 (stabilizer manufactured by Rahn) | 0.05 parts |
| Lucirin TPO | 8.5 parts |
| (photopolymerization initiator manufactured by BASF) | |
| Benzophenone (photopolymerization initiator) | 4.0 parts |
| Irgacure 184 | 4.0 parts |
| (photopolymerization initiator manufactured by CSC) | |
| BYK-307 (anti-foaming agent manufactured | 0.05 parts |
| by BYK Chemie) | |
| 9,10-Dibutoxyanthracene | 3.0 parts |

### Magenta Ink 1

| | |
|---|---|
| N-Vinyl-ε-caprolactam (manufactured by Aldrich) | 25.0 parts |
| Actilane 421 | 21.4 parts |
| (polyfunctional acrylate monomer manufactured by Akcros) | |
| Photomer 4017 | 10.0 parts |
| (1,6-hexanediol diacrylate, UV diluent | |
| manufactured by EChem) | |
| Solsperse 32000 (dispersant manufactured by Noveon) | 0.4 parts |
| Cinquasia Magenta RT-355D (pigment manufactured | 3.6 parts |
| by CSC) | |
| Genorad 16 (stabilizer manufactured by Rahn) | 0.05 parts |
| Rapi-Cure DVE-3 (vinyl ether manufactured by | 8.0 parts |
| ISP Europe) | |
| Lucirin TPO | 8.5 parts |
| (photopolymerization initiator manufactured by BASF) | |
| Benzophenone (photopolymerization initiator) | 4.0 parts |
| Irgacure 184 | 4.0 parts |
| (photopolymerization initiator manufactured by CSC) | |
| BYK-307 (anti-foaming agent manufactured | 0.05 parts |
| by BYK Chemie) | |
| 9,10-Dibutoxyanthracene | 3.0 parts |

### Cyan Ink 1

| | |
|---|---|
| N-Vinyl-ε-caprolactam (manufactured by Aldrich) | 25.0 parts |
| Actilane 421 | 21.4 parts |
| (polyfunctional acrylate monomer manufactured by Akcros) | |
| Photomer 4017 | 10.0 parts |
| (1,6-hexanediol diacrylate, UV diluent | |
| manufactured by EChem) | |
| Solsperse 32000 (dispersant manufactured by Noveon) | 0.4 parts |
| Irgalite Blue GLVO (pigment manufactured by CSC) | 3.6 parts |
| Genorad 16 (stabilizer manufactured by Rahn) | 0.05 parts |
| Rapi-Cure DVE-3 (vinyl ether manufactured by | 8.0 parts |
| ISP Europe) | |
| Lucirin TPO | 8.5 parts |
| (photopolymerization initiator manufactured by BASF) | |
| Benzophenone (photopolymerization initiator) | 4.0 parts |
| Irgacure 184 | 4.0 parts |
| (photopolymerization initiator manufactured by CSC) | |
| BYK-307 (anti-foaming agent manufactured by | 0.05 parts |
| BYK Chemie) | |
| 9,10-Dibutoxyanthracene | 3.0 parts |

### Black Ink 1

| | |
|---|---|
| N-Vinyl-ε-caprolactam (manufactured by Aldrich) | 25.0 parts |
| Actilane 421 | 25.4 parts |
| (polyfunctional acrylate monomer manufactured by Akcros) | |
| Photomer 4017 | 10.0 parts |
| (1,6-hexanediol diacrylate, UV diluent | |
| manufactured by EChem) | |
| Solsperse 32000 (dispersant manufactured by Noveon) | 0.4 parts |
| Microlith Black C-K (pigment manufactured by CSC) | 2.6 parts |
| Genorad 16 (stabilizer manufactured by Rahn) | 0.05 parts |
| Rapi-Cure DVE-3 (vinyl ether manufactured by | 5.0 parts |
| ISP Europe) | |
| Lucirin TPO | 8.5 parts |
| (photopolymerization initiator manufactured by BASF) | |
| Benzophenone (photopolymerization initiator) | 4.0 parts |
| Irgacure 184 | 4.0 parts |
| (photopolymerization initiator manufactured by CSC) | |
| BYK-307 (anti-foaming agent manufactured by | 0.05 parts |
| BYK Chemie) | |
| 9,10-Dibutoxyanthracene | 3.0 parts |

### White Ink 1

| | |
|---|---|
| N-Vinyl-ε-caprolactam (manufactured by Aldrich) | 25.0 parts |
| Actilane 421 | 18.0 parts |
| (polyfunctional acrylate monomer manufactured by Akcros) | |
| Photomer 4017 | 5.0 parts |
| (1,6-hexanediol diacrylate, UV diluent | |
| manufactured by EChem) | |
| Solsperse 32000 (dispersant manufactured by Noveon) | 0.4 parts |
| KRONOS 2300 (titanium oxide manufactured | 15.0 parts |
| by KRONOS) | |
| Genorad 16 (stabilizer manufactured by Rahn) | 0.05 parts |
| Rapi-Cure DVE-3 (vinyl ether manufactured by | 5.0 parts |
| ISP Europe) | |
| Lucirin TPO | 8.5 parts |
| (photopolymerization initiator manufactured by BASF) | |
| Benzophenone (photopolymerization initiator) | 4.0 parts |
| Irgacure 184 | 4.0 parts |
| (photopolymerization initiator manufactured by CSC) | |
| BYK-307 (anti-foaming agent manufactured by | 0.05 parts |
| BYK Chemie) | |
| 9,10-Dibutoxyanthracene | 3.0 parts |

The crude Inks 1 of each color prepared above were filtered using a filter having an absolute filtration accuracy of 2 μm to give Inks 1 of each color.

### Preparation of Cationically Polymerizable Inks

### Yellow Ink 2

| | |
|---|---|
| C.I. Pigment Yellow 13 | 5 parts |
| DISPER BYK-168 | 4 parts |
| (pigment-dispersing agent manufactured by BYK Chemie) | |
| Cationic photopolymerization initiator: triphenylsulfonium salt | 6 parts |
| (UVI-6992, manufactured by The Dow Chemical Company) | |
| Sensitizing dye: 9,10-dibutoxyanthracene | 3 parts |
| Polymerizable compounds | |
| Monomer: 3,4-epoxycyclohexylmethyl-3′,4′- | 30 parts |
| epoxycyclohexanecarboxylate (Celloxide 2021A: | |
| manufactured by Daicel-UCB Co., Ltd.) | |
| Monomer: 3,7-bis(3-oxetanyl)-5-oxanonane | 37 parts |
| (OXT-221: manufactured by Toagosei Co., Ltd.) | |

### Magenta Ink 2

| | |
|---|---|
| C.I. Pigment Red 57:1 | 5 parts |
| DISPER BYK-168 | 4 parts |
| (pigment-dispersing agent manufactured by BYK Chemie) | |
| Cationic photopolymerization initiator: triphenylsulfonium salt | 6 parts |
| (UVI-6992, manufactured by The Dow Chemical Company) | |
| Sensitizing dye: 9,10-dibutoxyanthracene | 3 parts |
| Polymerizable compounds | |
| Monomer: 3,4-epoxycyclohexylmethyl-3′,4′- | 30 parts |
| epoxycyclohexanecarboxylate (Celloxide 2021A: | |
| manufactured by Daicel-UCB Co., Ltd.) | |
| Monomer: 3,7-bis(3-oxetanyl)-5-oxanonane | 37 parts |
| (OXT-221: manufactured by Toagosei Co., Ltd.) | |

### Cyan Ink 2

| | |
|---|---|
| C.I. Pigment Blue 15:3 | 4 parts |
| DISPER BYK-168 | 3 parts |
| (pigment-dispersing agent manufactured by BYK Chemie) | |
| Cationic photopolymerization initiator: triphenylsulfonium salt | 6 parts |
| (UVI-6992, manufactured by The Dow Chemical Company) | |
| Sensitizing dye: 9,10-dibutoxyanthracene | 3 parts |
| Polymerizable compounds | |
| Monomer: 3,4-epoxycyclohexylmethyl-3′,4′- | 30 parts |
| epoxycyclohexanecarboxylate (Celloxide 2021A: | |
| manufactured by Daicel-UCB Co., Ltd.) | |
| Monomer: 3,7-bis(3-oxetanyl)-5-oxanonane | 39 parts |
| (OXT-221: manufactured by Toagosei Co., Ltd.) | |

### Black Ink 2

| | |
|---|---|
| C.I. Pigment Black 7 | 4 parts |
| DISPER BYK-168 | 3 parts |
| (pigment-dispersing agent manufactured by BYK Chemie) | |
| Cationic photopolymerization initiator: triphenylsulfonium salt | 6 parts |
| (UVI-6992, manufactured by The Dow Chemical Company) | |
| Sensitizing dye: 9,10-dibutoxyanthracene | 3 parts |
| Polymerizable compounds | |
| Monomer: 3,4-epoxycyclohexylmethyl-3′,4′- | 30 parts |
| epoxycyclohexanecarboxylate (Celloxide 2021A: | |
| manufactured by Daicel-UCB Co., Ltd.) | |
| Monomer: 3,7-bis(3-oxetanyl)-5-oxanonane | 39 parts |
| (OXT-221: manufactured by Toagosei Co., Ltd.) | |

### White Ink 2

| | |
|---|---|
| KRONOS 2300 (titanium oxide manufactured by KRONOS) | 15 parts |
| DISPER BYK-168 | 3 parts |
| (pigment-dispersing agent manufactured by BYK Chemie) | |
| Cationic photopolymerization initiator: triphenylsulfonium salt | 6 parts |
| (UVI-6992, manufactured by The Dow Chemical Company) | |
| Sensitizing dye: 9,10-dibutoxyanthracene | 3 parts |
| Polymerizable compounds | |
| Monomer: 3,4-epoxycyclohexylmethyl-3′,4′- | 28 parts |
| epoxycyclohexanecarboxylate (Celloxide 2021A: | |
| manufactured by Daicel-UCB Co., Ltd.) | |
| Monomer: 3,7-bis(3-oxetanyl)-5-oxanonane | 30 parts |
| (OXT-221: manufactured by Toagosei Co., Ltd.) | |

The crude yellow ink 2, magenta ink 2, cyan ink 2, black ink 2, and white ink 2 prepared above were filtered using a filter having an absolute filtration accuracy of 2 μm to give Inks of each color.

### Inkjet Image Recording

When printing, a printing system was used that was equipped with a one-pass head unit (recording width 542 mm) provided with 15 sets of head units having a nozzle density of 1080 dpi in which three shear mode piezo heads (KM512SH manufactured by Konica Minolta: minimum droplet size 4 pL, number of nozzles 512, nozzle density 360 nozzles/25.4 mm) were arranged in a staggered manner in the recording medium transport direction to thus achieve printing across the width direction of a recording medium.

A 10 L ink tank having a pressure reducing function was charged with ink, the pressure was reduced to −38 kPa to thus remove gas dissolved in the ink, and this ink was introduced to the above-mentioned head unit via a flexible polytetrafluoroethylene tube having an internal diameter of 2 mm through a hydrostatic pressure control tank (capacity 50 mL). By controlling the height of the hydrostatic pressure tank relative to the head, the internal pressure of the head could be adjusted to −5.0 kPa, thus controlling the shape of the meniscus in the head nozzle. Furthermore, the ink temperature within the head was made to be 55° C. by means of a heater incorporated into the head. Discharge was carried out in binary mode with a head drive voltage of 26 V and a drive frequency of 23 kHz.

The printing pitch was 1,080 dpi in the recording medium width direction×2,000 dpi in the recording medium transport direction (head scan speed 292 mm/s), that is, one pass printing was carried out while continuously transporting the recording medium. Furthermore, a UV light source (two VZero 270 units manufactured by Integration Technology disposed in the recording medium width direction) was placed on the downstream side of the head in the recording medium transport direction, and the ink printed on the recording medium was irradiated with UV rays. As cleaning means for the head, means for carrying out suction of the head nozzles and preliminary discharge was provided, and cleaning was carried out as appropriate.

The two types of evaluation below (A and B) were carried out using the above-mentioned inkjet discharge system.

### Evaluation A (Continuous Discharge Reliability)

Before operating the inkjet system, the ink washing liquid was circulated for 15 minutes to thus remove ink remaining in an ink contact section within the system. Subsequently, operation was carried out continuously for 8 hours, and the number of nozzles that had caused printing defects (no discharge, twist, etc.) was counted.

+++: no defects
++: 3 or less defective nozzles
+: 4 to 9 defective nozzles
−: 10 or more defective nozzles

In all cases, counting was carried out per head.

### Evaluation B (Nozzle Clogging Recovery)

A head that had been used continuously for 1 week without cleaning was subjected to cleaning with the ink washing liquid by circulating the liquid and discharging repeatedly for 15 minutes, the ink was supplied again, printing was carried out, and the number of nozzles that did not discharge was counted.

+++: no defects
++: 3 or less defective nozzles
+: 4 to 9 defective nozzles
−: 10 or more defective nozzles

In all cases, counting was carried out per head.

Printing was carried out using the above-mentioned printing system with inks of five colors (cyan, magenta, yellow, black, and white), and Evaluations A and B were carried out using the ink washing liquid (1). The results are given in Table 1. Printing was carried out using both radically polymerizable inks and cationically polymerizable inks.

### Example 1-1

### Ink Washing Liquid (1-1)

Tripropylene glycol monomethyl ether (manufactured by The Dow Chemical Company) 100 wt %

### Examples 1-2 to 1-12

Evaluation was carried out in the same manner as above except that the ink washing liquid (1-1) was replaced with the ink washing liquids (1-2) to (1-12) shown in Table 1.

The results are given in Table 1.

### Comparative Example 1

Evaluation was carried out in the same manner as above except that the ink washing liquid (1-1) was not used.

The results are given in Table 1.

### Comparative Example 2

Evaluation was carried out in the same manner as above except that the ink washing liquid (1-1) was replaced with Isopar G (an isoparaffin-based solvent, manufactured by Exxon Mobile Corporation).

The results are given in Table 1.

TABLE 1

| | | Radically | | Cationically | | |
|---|---|---|---|---|---|---|
| | | polymerizable | | polymerizable | | |
| | | ink | | ink | | |
| | | Evaluation type | | | | |
| Ex. No. | Ink washing liquid | A | B | A | B | Notes |
| Ex. 1-1 | (1) Tripropylene glycol monomethyl | +++ | +++ | ++ | ++ | − |
| | ether | | | | | |
| Ex. 1-2 | (2) Dipropylene glycol monomethyl | +++ | +++ | ++ | ++ | − |
| | ether | | | | | |
| Ex. 1-3 | (3) Propylene glycol monomethyl | +++ | +++ | ++ | ++ | − |
| | ether | | | | | |
| Ex. 1-4 | (4) Triethylene glycol divinyl ether | +++ | ++ | ++ | ++ | − |
| Ex. 1-5 | (5) Dipropylene glycol diacrylate | +++ | ++ | ++ | ++ | − |
| Ex. 1-6 | (6) 3-Methyl-3-methoxybutanol | +++ | ++ | ++ | ++ | − |
| Ex. 1-7 | (7) [(1)/(2) = 50/50 (wt %)] | +++ | ++ | ++ | ++ | − |
| Ex. 1-8 | (8) [(1)/(3) = 50/50 (wt %)] | +++ | ++ | ++ | ++ | − |
| Ex. 1-9 | (9) [(1)/(6) = 50/50 (wt %)] | +++ | ++ | ++ | ++ | − |
| Ex. 1-10 | (10) [(1)/(4)/(12) = 50/25/25 (wt %)] | +++ | ++ | ++ | ++ | − |
| Ex. 1-11 | (11) [(2)/(5)/(12) = 50/25/25 (wt %)] | +++ | ++ | ++ | ++ | − |
| Comp. | None | − | − | − | − | − |
| Ex. 1-1 | | | | | | |
| Comp. | Isopar G | − | − | − | − | Ink |
| Ex. 1-2 | | | | | | aggregated |

(12) γ-Caprolactone

### Example 2-1

### Ink Washing Liquid (2-1)

| | |
|---|---|
| DISPER BYK-168 (manufactured by BYK) | 10 parts |
| Tripropylene glycol monomethyl ether | 100 parts |
| (manufactured by The Dow Chemical Company) | |

### Examples 2-2 to 2-9

Evaluation was carried out in the same manner as above except that the ink washing liquid (2-1) was replaced with the ink washing liquids (2-2) to (2-9) shown in Table 2.

The results are given in Table 2.

### Comparative Example 2-1

### Evaluation was carried out in the same manner as above except that the ink washing liquid (2-1) was not used.

The results are given in Table 2.

TABLE 2

| | | | Radically | | Cationically | |
|---|---|---|---|---|---|---|
| | | | polymerizable | | polymerizable | |
| | | | ink | | ink | |
| | Ink washing liquid | | Evaluation type | | | |
| Ex. No. | Ether compound | Pigment-dispersing agent | A | B | A | B |
| Ex. 2-1 | (1) 90 parts by | DISPER BYK-168 10 parts by | +++ | +++ | +++ | ++ |
| | weight | weight | | | | |
| Ex. 2-2 | (1) 80 parts by | DISPER BYK-168 20 parts by | +++ | +++ | ++ | ++ |
| | weight | weight | | | | |
| Ex. 2-3 | (1) 95 parts by | DISPER BYK-168 5 parts by | +++ | +++ | ++ | ++ |
| | weight | weight | | | | |
| Ex. 2-4 | (1) 90 parts by | SOLSPERSE 36000 10 parts by | +++ | +++ | ++ | ++ |
| | weight | weight | | | | |
| Ex. 2-5 | (1) 90 parts by | SOLSPERSE 41000 10 parts by | +++ | +++ | ++ | ++ |
| | weight | weight | | | | |
| Ex. 2-6 | (1) 90 parts by | SOLSPERSE 39000 10 parts by | +++ | +++ | ++ | ++ |
| | weight | weight | | | | |
| Ex. 2-7 | (1) 90 parts by | SOLSPERSE 71000 10 parts by | +++ | +++ | ++ | ++ |
| | weight | weight | | | | |
| Ex. 2-8 | (1) 90 parts by | SOLSPERSE 32000 10 parts by | +++ | +++ | ++ | ++ |
| | weight | weight | | | | |
| Ex. 2-9 | (1) 90 parts by | DISPER BYK-168 5 parts by | +++ | +++ | ++ | ++ |
| | weight | weight | | | | |
| | | SOLSPERSE 32000 5 parts by | | | | |
| | | weight | | | | |
| Comp. | None | None | − | − | − | − |
| Ex. 2-1 | | | | | | |

(1) Tripropylene glycol monomethyl ether (manufactured by The Dow Chemical Company)
DISPER BYK-168 (manufactured by BYK)
SOLSPERSE 32000, 36000, 39000, 41000, 71000 (manufactured by Noveon)

### Example 3-1

### Ink Washing Liquid (3-1)

| | |
|---|---|
| Tripropylene glycol monomethyl ether | 90 parts |
| (manufactured by The Dow Chemical Company) | |
| Diethanolamine (manufactured by Tokyo | 10 parts |
| Chemical Industry Co., Ltd.) | |

### Examples 3-2 to 3-12

Evaluation was carried out in the same manner as above except that the ink washing liquid (3-1) was replaced with the ink washing liquids (3-2) to (3-12) shown in Table 3.

The results are given in Table 3.

### Comparative Example 3-1

Evaluation was carried out in the same manner as above except that the ink washing liquid (3-1) was not used.

The results are given in Table 3.

### Example 4-1

Evaluation was carried out in the same manner as above except that the ink washing liquid (3-1) was replaced with the ink washing liquid (4-1) shown in Table 3.

The results are given in Table 3.

TABLE 3

| | | | Radically | | Cationically | |
|---|---|---|---|---|---|---|
| | | | polymerizable | | polymerizable | |
| | | | ink | | ink | |
| | Ink washing liquid | | Evaluation type | | | |
| Ex. No. | No. | Composition | A | B | A | B |
| Ex. 3-1 | (1) | Tripropylene glycol monomethyl ether (Dow Chemical) 90 parts by weight | +++ | +++ | +++ | ++ |
| | | Diethanolamine (Tokyo Chemical) 10 parts by weight | | | | |
| Ex. 3-2 | (2) | Tripropylene glycol monomethyl ether (Dow Chemical) 80 parts by weight | +++ | +++ | ++ | ++ |
| | | Diethanolamine (Tokyo Chemical) 20 parts by weight | | | | |
| Ex. 3-3 | (3) | Tripropylene glycol monomethyl ether (Dow Chemical) 90 parts by weight | +++ | +++ | ++ | ++ |
| | | 3-Aminopropyltrimethoxysilane (Shin-Etsu Chemical) 10 parts by weight | | | | |
| Ex. 3-4 | (4) | Tripropylene glycol monomethyl ether (Dow Chemical) 90 parts by weight | +++ | +++ | ++ | ++ |
| | | 3-Dimethylaminopropyltrimethoxysilane (Tokyo Chemical) 10 parts by weight | | | | |
| Ex. 3-5 | (5) | Tripropylene glycol monomethyl ether (Dow Chemical) 90 parts by weight | +++ | +++ | ++ | ++ |
| | | Diethyl-n-butylamine (Tokyo Chemical) 10 parts by weight | | | | |
| Ex. 3-6 | (6) | Tripropylene glycol monomethyl ether (Dow Chemical) 90 parts by weight | +++ | +++ | ++ | ++ |
| | | Imidazole (Tokyo Chemical) 10 parts by weight | | | | |
| Ex. 3-7 | (7) | Tripropylene glycol monomethyl ether (Dow Chemical) 90 parts by weight | +++ | +++ | ++ | ++ |
| | | Dipropanolamine (Tokyo Chemical) 10 parts by weight | | | | |
| Ex. 3-8 | (8) | Triethylene glycol divinyl ether (Dow Chemical) 90 parts by weight | +++ | +++ | ++ | ++ |
| | | Diethanolamine (Tokyo Chemical) 10 parts by weight | | | | |
| Ex. 3-9 | (9) | Dipropylene glycol monomethyl ether (Dow Chemical) 90 parts by weight | +++ | +++ | ++ | ++ |
| | | Diethanolamine (Tokyo Chemical) 10 parts by weight | | | | |
| Ex. 3-10 | (10) | 3-Methyl-3-methoxybutanol (Dow Chemical) 90 parts by weight | +++ | +++ | ++ | ++ |
| | | Dipropanolamine (Tokyo Chemical) 10 parts by weight | | | | |
| Ex. 3-11 | (11) | Tripropylene glycol monomethyl ether (Dow Chemical) 90 parts by weight | +++ | +++ | ++ | ++ |
| | | Diethanolamine (Tokyo Chemical) 5 parts by weight | | | | |
| | | 3-Aminopropyltrimethoxysilane (Shin-Etsu Chemical) 5 parts by weight | | | | |
| Ex. 3-12 | (12) | Tripropylene glycol monomethyl ether (Dow Chemical) 90 parts by weight | +++ | +++ | ++ | ++ |
| | | Dipropanolamine (Tokyo Chemical) 5 parts by weight | | | | |
| | | Diethylphenylamine (Tokyo Chemical) 5 parts by weight | | | | |
| Comp. Ex. 3-1 | — | None | − | − | − | − |

What is claimed is:

1. An ink washing liquid for a photocurable ink, the liquid comprising:
at least one type of ether compound.

2. The ink washing liquid according to claim 1, wherein the ether compound is a glycol ether compound.

3. The ink washing liquid according to claim 1, wherein the photocurable ink is a radically polymerizable ink.

4. A cleaning method for an inkjet printer, the method comprising:
cleaning an inkjet printer with the ink washing liquid according to claim 1.

5. The washing liquid according to claim 1, wherein it further comprises at least one type of pigment-dispersing agent.

6. The ink washing liquid according to claim 5, wherein the ether compound is a glycol ether compound.

7. The ink washing liquid according to claim 5, wherein the photocurable ink is a radically polymerizable ink.

8. A cleaning method for an inkjet printer, the method comprising:
cleaning an inkjet printer with the ink washing liquid according to claim 5.

9. The washing liquid according to claim 1, wherein it further comprises at least one type of basic compound.

10. The ink washing liquid according to claim 9, wherein the ether compound is a glycol ether compound.

11. The ink washing liquid according to claim 9, wherein the basic compound is an organic amine.

12. The ink washing liquid according to claim 9, wherein the photocurable ink is a radically polymerizable ink.

13. A cleaning method for an inkjet printer, the method comprising:
cleaning an inkjet printer with the ink washing liquid according to claim 9.
